(19) United States
(12) Patent Application Publication
(10) Pub. No.: US 2016/0116814 A1
(43) Pub. Date: Apr. 28, 2016

(54) DISPLAY PANEL AND DISPLAY DEVICE

(71) Applicant: SHARP KABUSHIKI KAISHA, Osaka-shi, Osaka (JP)

(72) Inventors: Tomoko TERANISHI, Osaka (JP); Eiji SATOH, Osaka (JP); Takuma TOMOTOSHI, Osaka (JP); Takahiro NAKAHARA, Osaka (JP)

(73) Assignee: SHARP KABUSHIKI KAISHA, Osaka-shi , Osaka (JP)

(21) Appl. No.: 14/784,356

(22) PCT Filed: Feb. 27, 2014
(86) PCT No.: PCT/JP2014/054900

§ 371 Date: Oct. 14, 2015

(30) Foreign Application Priority Data
Apr. 15, 2013 (JP) 2013-085291

(51) Int. Cl. G02F 1/167

(52) U.S. Cl. CPC G02F 1/167; G02F 2001/1678

(57) ABSTRACT

A modulation layer in a display device is made of a dispersion liquid including: a plurality of shape-anisotropic members that, by rotating or moving in accordance with changes in the magnitude of frequency of an applied voltage, change the area thereof projected onto substrates in a direction normal to the substrates; a dispersion medium; and a thickening agent. When shear stress applied to the dispersion liquid is high, the thickening agent reduces the viscosity of the dispersion liquid more than when shear stress is low.

### TECHNICAL FIELD

The present invention relates to a display panel and a display device.

### BACKGROUND ART

In recent years, there has been progress in developing a display panel that has, sealed between a pair of substrates, a dispersion liquid having small flake-like shape-anisotropic members dispersed in a dispersion medium. In this display panel, the alignment of the shape-anisotropic members is caused to change in order to modulate the transmittance of light. Such a display panel is called a “flake display,” for example.

Patent Documents 1 and 2 disclose, as examples of a flake display, optical devices having flakes suspended in a fluid host, whereby changes to the electric field applied to the fluid host causes the alignment of the flakes to change.

In the flake display, light reflectance and absorption allows for a display having favorable contrast, and it is possible to omit the polarization plates needed for a liquid crystal panel; thus, light usage efficiency in a flake display can be improved more than in a liquid crystal panel.

### RELATED ART DOCUMENTS

### Patent Documents

Patent Document 1: U.S. Pat. No. 6,665,042 (published on Dec. 16, 2003)

Patent Document 2: U.S. Pat. No. 6,829,075 (published on Dec. 7, 2004)

### SUMMARY OF THE INVENTION

### Problems to be Solved by the Invention

Research by the inventors of the present application, however, shows that conventional flake displays have deviations in the density of the shape-anisotropic members inside the dispersion liquid, which results in display anomalies such as uneven brightness, occurrence of non-display areas, and the like.

One reason for this includes the difference in specific gravity between the shape-anisotropic members and the dispersion medium. When there is a difference in specific gravity between the shape-anisotropic members and the dispersion member, the effects of gravity cause the shape-anisotropic members in the dispersion liquid to float or sink.

FIGS. 24(a) and 24(b) are schematic views for explaining the principle behind display anomalies in conventional flake displays. It should be noted that FIGS. 24(a) and 24(b) show an example in which the specific gravity of shape-anisotropic members 132 is greater than the specific gravity of the dispersion medium 131.

As shown in FIG. 24(a), when there is a difference in specific gravity between the shape-anisotropic members 132 and the dispersion medium 131, using the flake display when the display surface 101 is upright causes the shape-anisotropic members 132 to sink gradually to the bottom of the flake display, thereby gradually reducing the number of shape-anisotropic members 132 at the top of the display, for example. This results in a difference in density of the shape-anisotropic members 132 between the top and bottom of the flake display, which causes display anomalies.

Furthermore, as shown in FIG. 24(b), if the flake display is used while the display surface 101 is horizontal, then the shape-anisotropic members 132 move in plane in the dispersion medium 131. This results in deviations of the shape-anisotropic members 132 in the in-plane direction, which hinders light transmittance modulation.

It should be noted that, even if the specific gravity between the shape-anisotropic members 132 and the dispersion medium 131 is equal, differences in electric field strength between areas where the electric field is weak, such as areas where pixel electrodes are not provided, and areas where the electric field is strong, such as areas where pixel electrodes are provided, causes the shape-anisotropic members 132 to move in plane.

As a countermeasure, it is possible to increase the viscosity of the dispersion liquid 130 to suppress temporal movement (rising, falling, in-plane movement, etc.) of the shape-anisotropic members 132, which is a cause of display anomalies. If the viscosity of the dispersion liquid 130 is increased, however, more energy is needed for alignment control of the shape-anisotropic members 132 to modulate the transmittance of light.

The present invention was made in view of the above-mentioned problems, and an aim thereof is to provide a display panel and a display device that can prevent display anomalies caused by deviations of the shape-anisotropic members without hindering drive performance to the greatest extent possible.

### Means for Solving the Problems

In order to solve the above-mentioned problems, in one aspect of the present invention, a display panel includes: a first substrate and a second substrate facing each other; and a light modulation layer sandwiched between the first substrate and the second substrate for controlling transmittance of incident light in accordance with changes in frequency of a voltage applied to the light modulation layer, wherein the light modulation layer is made of a dispersion liquid that includes: a plurality of shape-anisotropic members that rotate or move in accordance with changes in the frequency or magnitude of the voltage applied to the light modulation layer so as to change an area of the shape-anisotropic members projected onto the first and second substrates as seen from a direction normal to the first and second substrates; a dispersion medium that disperses the shape-anisotropic members; and a thickening agent, and wherein the thickening agent is such that, when shear stress applied to the dispersion liquid is high, the thickening agent reduces the viscosity of the dispersion liquid to be less than when shear stress is low.

In another aspect of the present invention, a display device includes the abovementioned display panel.

### Effects of the Invention

According to one embodiment of the present invention, by having the dispersion liquid include the thickening agent, it is possible to suppress deviations of the shape-anisotropic members such as floating, sinking, or in-plane movement of the shape-anisotropic members due to the viscosity of the dispersion liquid increasing when the shear stress applied to the dispersion liquid is low. Meanwhile, during alignment change of the shape-anisotropic members, the rotating or moving of the shape-anisotropic members increases the shear stress applied to the dispersion liquid, which lowers the viscosity of the dispersion liquid and does not hinder the movement of the shape-anisotropic members. Therefore, it is possible to prevent display anomalies caused by deviations of the shape-anisotropic members without hindering drive performance to the greatest extent possible. Furthermore, while the shape-anisotropic members are at rest, the viscosity of the dispersion liquid increases, which makes it possible to maintain the alignment of the shape-anisotropic members. This allows for memory display.

### BRIEF DESCRIPTION OF THE DRAWINGS

FIGS. 1(a) to 1(h) are cross-sectional views that show a schematic configuration of a display device of Embodiment 1.

FIG. 2 is a structural scheme that schematically shows one example of the chemical structure of a polymer used as an organic rheological control agent that expresses thixotropic characteristics.

FIG. 3 is a view schematically showing a three-dimensional polymer network when using the polymer shown in FIG. 2 as an organic rheological control agent according to Embodiment 1.

FIG. 4 is a graph showing the viscosity curve of a Newtonian fluid and a non-Newtonian fluid expressing thixotropic characteristics.

FIG. 5 is a schematic view in step order of a preparation method of the dispersion liquid including, as a thickening agent, an organic rheological control agent that expresses thixotropic characteristics.

FIGS. 6(a) to 6(c) are views of pictures showing crystalline growth over time when a solvent-based organic rheological control agent that expresses thixotropic characteristics is used a thickening agent.

FIGS. 7(a) to 7(d) are photomicrographs showing the dispersion liquid including the rheological control agent being driven by voltage.

FIGS. 8(a) and 8(b) show the anti-sedimentation effects of the dispersion liquid including the rheological control agent.

FIGS. 9(a) and 9(b) are cross-sectional views showing a modification example of the display device in FIGS. 1(a) to 1(h).

FIG. 10 is a schematic view showing a three-dimensional polymer network used as an organic rheological control agent that expresses pseudoplasticity alongside one example of the chemical structure of the polymers.

FIG. 11 is a graph showing the viscosity curve of a non-Newtonian fluid expressing pseudoplasticity.

FIG. 12 is a schematic view in step order of a preparation method of the dispersion liquid as a thickening agent, the dispersion liquid having the organic rheological control agent that expresses pseudoplasticity.

FIG. 13 is a schematic view of a three-dimensional network of a wetting & dispersant agent.

FIG. 14 is a view of results confirming stable dispersion of the rheological control agent by using a different material as an inorganic rheological control agent.

FIG. 15(a) is a schematic perspective view of the general configuration of a display panel according to Embodiment 4, FIG. 15(b) are images taken of the area in FIG. 15(a) shown by the dotted lines when the inorganic rheological control agent was used a thickening agent, and FIG. 15(c) are images taken of the area in FIG. 15(a) shown by the dotted lines when the organic rheological control agent was used a thickening agent.

FIGS. 16(a) to 16(d) are photomicrographs showing a display panel according to Embodiment 4 being driven by voltage.

FIG. 17 is a schematic view of a bentonite (montmorillonite) card-house structure.

FIGS. 18(a) and 18(b) are cross-sectional views that show a schematic configuration of a reflective display device according to one aspect of the present invention.

FIG. 19 is a cross-sectional view of a schematic configuration of a reflective display device according to another aspect of the present invention.

FIGS. 20(a) and 20(b) are cross-sectional views that show a schematic configuration of a see-through display device according to one aspect of the present invention.

FIGS. 21(a) and 21(b) are cross-sectional views that show a schematic configuration of a transflective display device according to one aspect of the present invention.

FIGS. 22(a) to 22(c) are cross-sectional views that show one example of a schematic configuration of a display device using bowl-type shape-anisotropic members.

FIGS. 23(a) and 23(b) are cross-sectional views that show one example of a schematic configuration of a display device 1 using fiber-like shape-anisotropic members 32.

FIGS. 24(a) and 24(b) are schematic views for explaining the principle behind display anomalies in conventional flake displays.

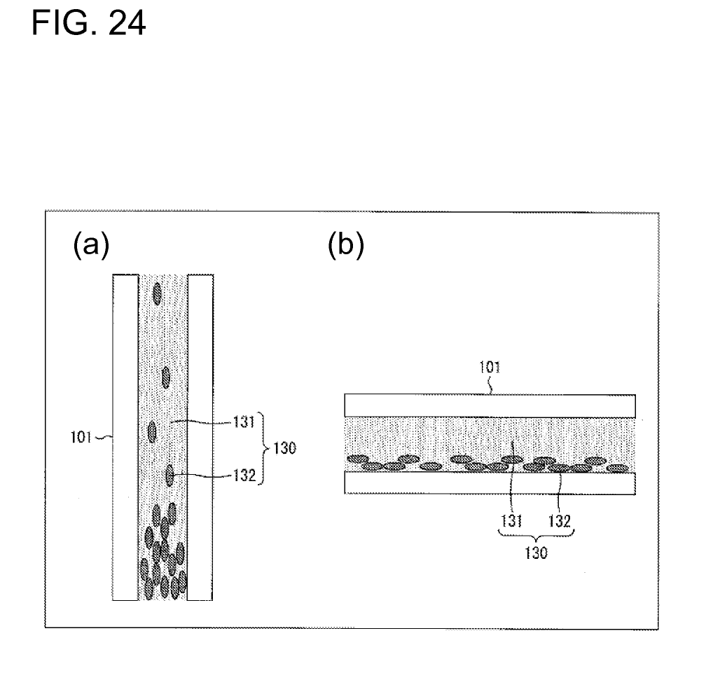

### DETAILED DESCRIPTION OF EMBODIMENTS

### Embodiment 1

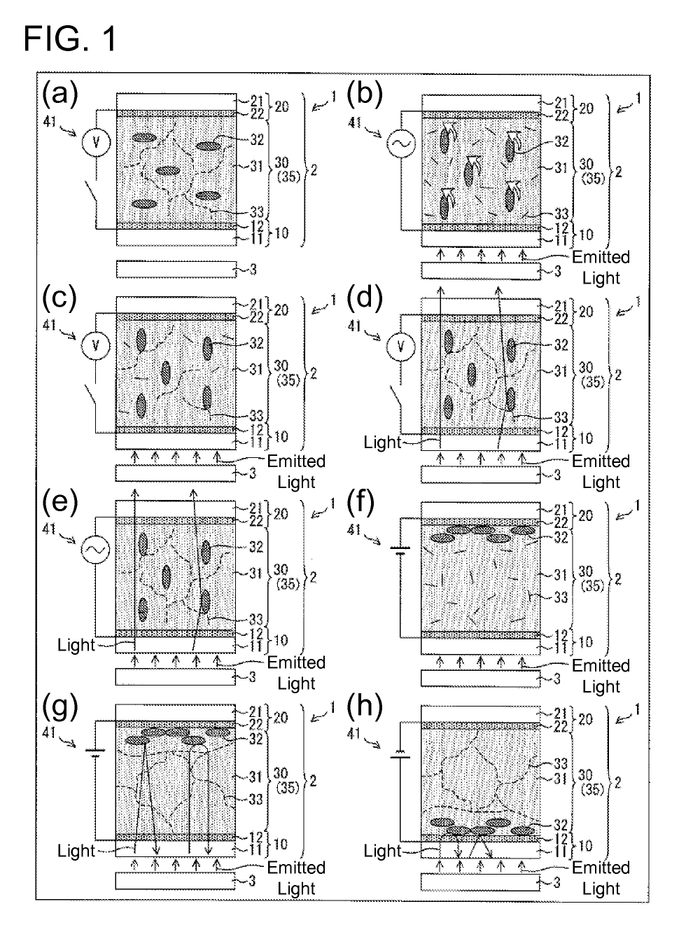

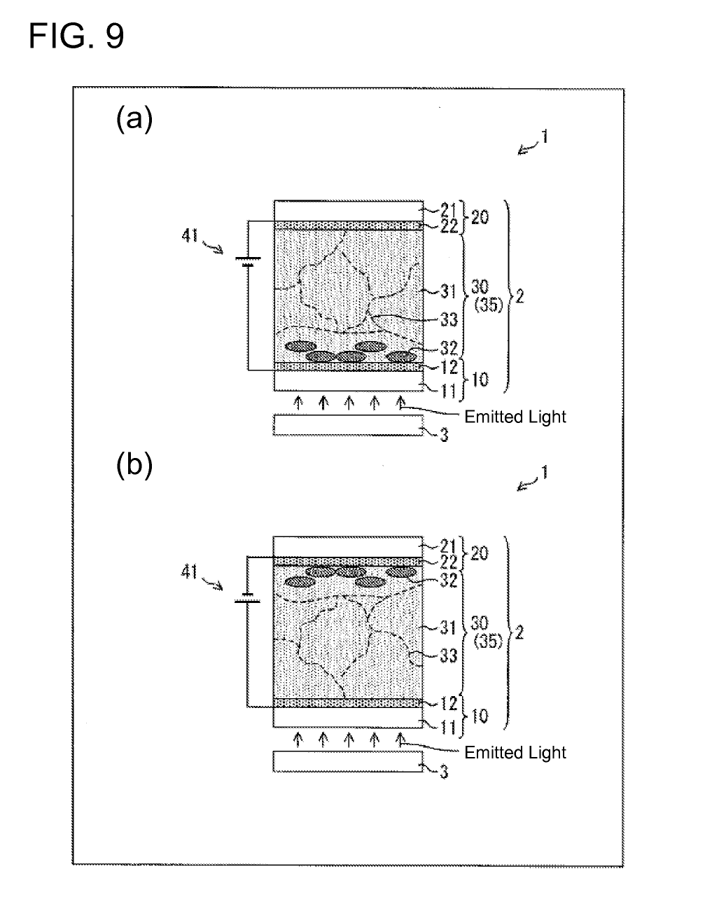

FIGS. 1(a) to 1(h) and FIGS. 9(a) and 9(b) will be used to explain one aspect of the present invention below.

(Schematic Configuration of Display Device)

FIGS. 1(a) to 1(h) are cross-sectional views that show a schematic configuration of a display device 1 of Embodiment 1. It should be noted that FIGS. 1(a) to 1(h) each schematically show behavior of shape-anisotropic members 32 in a light modulation layer 30 of the display device 1.

As shown in FIGS. 1(a) to 1(h), the display device 1 includes a display panel 2, a backlight 3 for illuminating the display panel 2, and a drive circuit (not shown). The display device 1 is a transmissive display device that performs display by light emitted from the backlight 3 passing through the display panel 2.

It should be noted that the backlight 3 has a conventional configuration. Accordingly, an explanation of the configuration of the backlight 3 will be omitted. The backlight 3 can be an edge-lit or direct-lit planar light source device or the like as appropriate, for example. The light source of the backlight 3 may be fluorescent tubes, LEDs, or the like as appropriate.

(Schematic Configuration of Display Panel 2)

The display panel 2 includes a pair of substrates 10 and 20 arranged to face each other and a light modulation layer 30 provided between this pair of substrates 10 and 20. The substrate 10 (first substrate) is disposed on the backlight 3 side (rear surface side), and the substrate 20 (second substrate) is disposed on the display surface side (viewer's side). The display panel 2 also has a large number of pixels arrayed in a matrix.

(Substrates 10 and 20)

The substrates 10 and 20 each include an insulating substrate constituted by a transparent glass substrate and electrodes 12 (first electrodes) and 22 (second electrode), for example.

The substrate 10 is an active matrix substrate. Specifically, the substrate 10 includes, on the glass substrate 11 (insulating substrate), various types of signal lines (scan signal lines, data signal lines, etc.), TFTs (thin film transistors), an insulating film (none of which are shown in the drawings), and electrodes 12 (pixel electrodes) on top of these, for example. The drive circuits for driving the various types of signal lines (scan signal line drive circuit, data signal line drive circuit, etc.) have conventional configurations.

The substrate 20 includes a transparent glass substrate 21 as an insulating substrate, and the electrode 22 (common electrode) on the glass substrate 21, for example.

The electrodes 12 formed on the substrate 10 and the electrode 22 formed on the substrate 20 are transparent conductive films such as ITO (indium-tin-oxide), IZO (indium-zinc-oxide), zinc oxide, tin oxide, or the like. Furthermore, the electrodes 12 are divided for each pixel, whereas the electrode 22 is formed in a block-shape and is common to all of the pixels. It should be noted that the electrode 22 may also be divided for each pixel, in a similar manner to the electrodes 12.

(Light Modulation Layer 30)

The light modulation layer 30 is a dispersion liquid layer made of a dispersion liquid 35 in which a plurality of the shape-anisotropic members 32 are dispersed. The dispersion liquid 35 is a non-Newtonian fluid that includes the dispersion medium 31, the plurality of shape-anisotropic members 32 dispersed in the dispersion medium 31, and a thickening agent 33 that, when shear stress becomes high, reduces the viscosity of the dispersion medium 31 more than when shear stress is low.

The light modulation layer 30 receives a voltage from a power source 41 connected to the electrodes 12, 22 and, in accordance with changes in frequency of the applied voltage, causes the transmittance of light from the backlight 3 incident on the modulation layer 30 to change. It should be noted that, hereinafter, cases where an alternating-current voltage frequency is 0 Hz will be referred to as “direct current.” The thickness (cell thickness) of the light modulation layer 30 is set by the length in the long-axis direction of the shape-anisotropic members 32, and is set at 80 μm, for example.

(Shape-Anisotropic Members 32)

The shape-anisotropic members 32 are response members having shape-anisotropy whereby the members rotate or move in response to changes in the magnitude or frequency of the voltage applied to the light modulation layer 30. In terms of display characteristics, the shape-anisotropic members 32, in a plan view (i.e., when seen in a direction normal to the substrates 10 and 20), have an area projected onto the substrates 10 and 20 that changes in response to changes in the magnitude or frequency of the voltage applied to the light modulation layer 30.

Due to this, causing the shape-anisotropic members 32 to rotate or move by changing the magnitude or frequency of the applied voltage changes the projected area of the shape-anisotropic members 32 in a plan view, thereby controlling the transmittance of light entering the light modulation layer 30. It should be noted that, hereinafter, examples in which the frequency, rather than magnitude, of the voltage applied to the light modulation layer 30 will mainly be described.

It is preferable that the projected area ratio (maximum projected area:minimum projected area) be at least 2:1.

The shape-anisotropic members 32 have a positive or negative charge in the dispersion medium 31. Specifically, the shape-anisotropic members can be members with which it is possible for electrodes, the medium, or the like to interact with electrons, or members that have been modified with an ionic silane coupling agent or the like, for example.

The shape of the shape-anisotropic members 32 can be flake-like, columnar, ovular, or the like, for example. The shape-anisotropic members 32 can be made of a metal, a semiconductor, a dielectric body, or a composite of these. Furthermore, it also possible to use a dielectric multilayer film or a cholesteric resin. Moreover, when using metal for the shape-anisotropic members 32, it is possible to use aluminum flakes as used in normal coating applications. The shape-anisotropic members 32 may be colored.

The thickness of the shape-anisotropic members 32 has no particular limitations, but the thinner the shape-anisotropic members 32, the more transmittance can be enhanced. Accordingly, when using flakes as the shape-anisotropic members 32, for example, it is preferable that the thickness thereof be 1 μm or less, and even more preferable that the thickness be 0.1 μm or less. Aluminum flakes having a diameter of 20 μm and a thickness of 0.3 μm can be used as the shape-anisotropic members 32, for example.

(Dispersion Medium 31)

The dispersion medium 31 is a material having transmissive characteristics in the visible light spectrum. It is possible to use a fluid that is largely not absorbed in the visible light spectrum or such a material that has been colored with a pigment for the dispersion medium 31.

In addition, it is preferable that the dispersion medium 31 be a material having low volatility, in consideration of the process for sealing the medium in the cells.

The viscosity of the dispersion medium 31 contributes to responsiveness. As described above, adding the thickening agent 33 to the dispersion medium 31 increases the viscosity of the dispersion medium (i.e., viscosity of the dispersion liquid 35 including the thickening agent 33) during rest (state in which the dispersion medium 31 is not flowing) of the shape-anisotropic members 32.

Therefore, it is preferable the dispersion medium 31 be selected with consideration given to the fact that the thickening agent 33 will increase viscosity. It should be noted that, if the viscosity of the dispersion liquid 35 (dispersion medium 31) becomes high, more energy will be required for alignment control of the shape-anisotropic members 32 for light transmittance modulation.

Thus, it is preferable that the viscosity of the dispersion medium 31 before the thickening agent 33 is applied and the viscosity of the dispersion medium 31 under shear stress after the thickening agent 33 is applied, i.e., when the shape-anisotropic members 32 are rotating or moving, be set within a range of 0.5 mPa·s to 5 mPa·s.

Furthermore, in order not to hinder starting operation of alignment change of the shape-anisotropic members 32 and to prevent deviations such as sedimentation of the shape-anisotropic members 32, it is preferable that the viscosity of the dispersion medium 31 at rest, i.e., not under shear stress, be within a range of 0.5 mPa·s to 500 mPa·s, or more preferably, 1 mPa·s to 100 mPa·s.

It should be noted that the dispersion medium 31 may be a single material or a mixture of a plurality of materials. The dispersion medium 31 can be an organic solvent such as propylene carbonate, NMP (N-methyl-2-pyrrolidone), fluorocarbon, silicone oil, or the like, for example.

(Thickening Agent 33)

A thickening agent is one type of additive for increasing viscosity by application thereof. Application of the thickening agent to the dispersion medium 31 can increase the viscosity of the dispersion medium 31 over pre-application, thereby making it possible to increase the viscosity of the dispersion liquid 35.

It is preferable that the viscosity of the dispersion liquid 35, however, be high when the shape-anisotropic members 32 are at rest, and low when the shape-anisotropic members 32 are moving (i.e., when changing alignment).

To achieve this, the thickening agent 33, which causes the viscosity of the dispersion liquid 35 to change in response to shear stress as described above, is added to control the fluidity of the dispersion liquid 35.

In the present embodiment, the additive having a thickening effect on the dispersion medium 31 upon application and reducing the viscosity of the dispersion medium 31 (viscosity of the dispersion liquid 35) more when shear stress is high than when shear stress is low will be referred to as “the thickening agent that reduces the viscosity of the dispersion medium more when shear stress is high than when shear stress is low.”

The thickening agent 33, in the dispersion liquid 35, forms a reversible three-dimensional mesh structure that maintains its structure when shear stress is low, and is destroyed when shear stress is high.

This type of thickening agent 33 exhibits a thickening effect by application to the dispersion medium 31 and increases viscosity of the dispersion liquid 35 when shear stress is low while decreasing viscosity of the dispersion liquid 35 when shear stress is high.

It should be noted that if the shape-anisotropic members 32 rotate or move as part of alignment operation, the dispersion liquid 35 will flow and shear stress will be applied to the dispersion liquid 35.

Therefore, when the shape-anisotropic members 32 are at rest, i.e., not changing alignment with a low amount of flow of the dispersion liquid 35 (low shear stress state), the thickening agent 33 forms a three-dimensional mesh structure, thereby increasing viscosity of the dispersion liquid 35, whereas if the alignment change of the shape-anisotropic members 32 causes the dispersion liquid 35 to flow and shear stress to be applied to the dispersion liquid 35, the three-dimensional mesh structure of the thickening agent 33 is destroyed and the viscosity of the dispersion liquid 35 decreases to lower than when the shape-anisotropic members 32 are at rest.

A rheological control agent, a wetting & dispersant agent, or the like can be used as the thickening agent 33, for example.

If a rheological control agent or a wetting & dispersant agent is applied to the dispersion medium 31 as the thickening agent 33, then pseudoplastic or thixotropic characteristics can be imparted to the resulting dispersion liquid 35, for example, thereby allowing for the viscosity of the dispersion liquid 35 to be changed in response to shear stress.

It should be noted that the thickening agent 33 may be a pseudoplasticity-imparting agent (pseudoplasticity-promoting agent) that imparts pseudoplasticity to the dispersion liquid 35, or may be a thixotropic agent (thixotropic-imparting agent/thixotropic-promoting agent) that imparts thixotropic characteristics to the dispersion liquid 35.

This rheological control agent or wetting & dispersant agent may be a commercially available rheological control agent or a commercially available wetting & dispersant agent ordinarily used for preventing pigment aggregation.

It should be noted that the rheological control agent may be an organic rheological control agent such as an associated thickening agent (associated rheological control agent) that forms a three-dimensional network via hydrogen bonding, for example, or an inorganic rheological control agent such as an inorganic nanoparticle rheological control agent or an inorganic clay mineral rheological control agent, for example.

Furthermore, the thickening agent 33, depending on the type, may be solvent based, non-solvent based, or liquid. In this context, “solvent based” means that the thickening agent 33 is dissolved into a solvent.

(Rheological Control Agent)

Hereinafter, in the present embodiment, an example will be described in which the thickening agent 33 is an organic rheological control agent expressing thixotropic characteristics.

The organic rheological control agent expressing thixotropic characteristics is an associated rheological control agent including crystalline polymers having areas with association effects, for example.

The rheological control agent has a sufficient solubility (sufficient insolubility) for the dispersion medium 31 of the shape-anisotropic members 32. A rheological control agent having association areas with low solubility in regards to the dispersion medium 31 are selected.

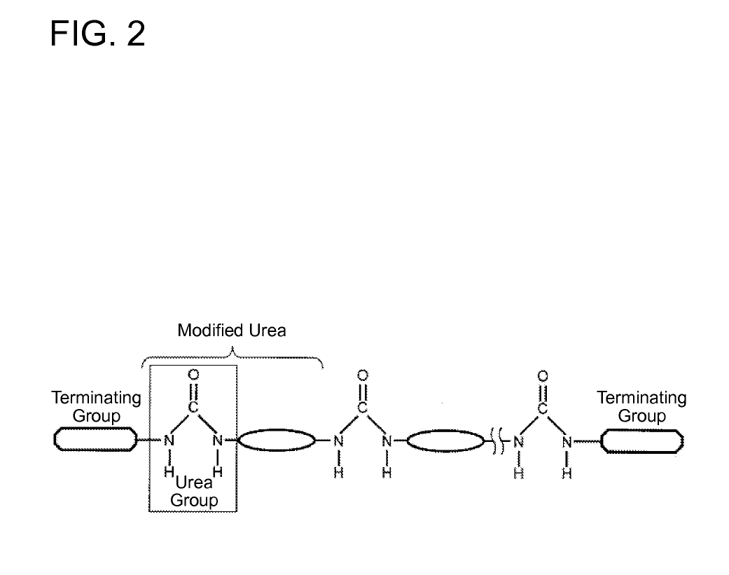

FIG. 2 is a structural scheme that schematically shows one example of the chemical structure of a polymer used as an organic rheological control agent that expresses thixotropic characteristics.

The polymer is a modified urea polymer having the chemical structure shown in FIG. 2, for example.

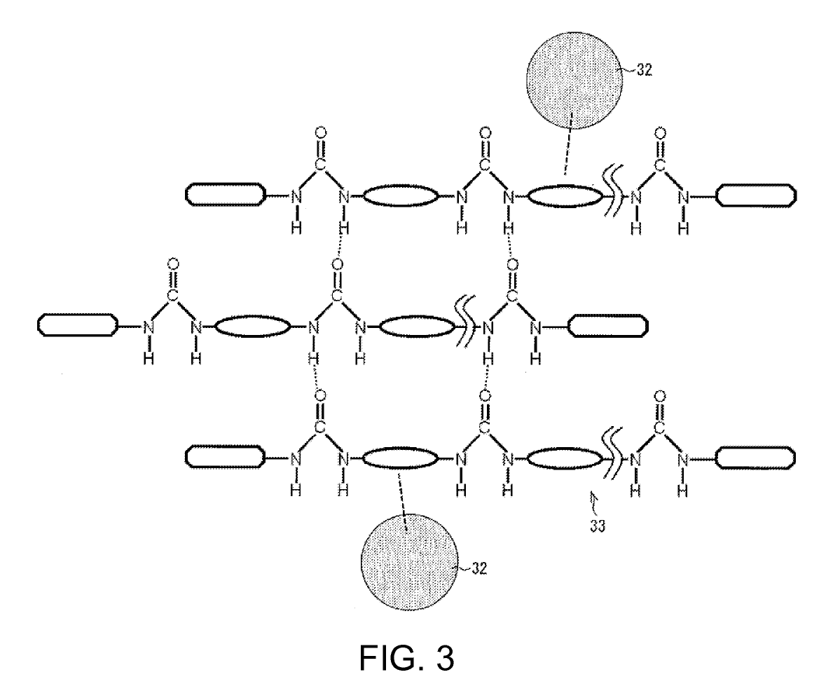

FIG. 3 is a view schematically showing a three-dimensional polymer network when using the polymer shown in FIG. 2 as the organic rheological control agent according to the present embodiment.

The polymers in FIGS. 2 and 3 are modified urea polymers having urea groups in the main chain. Between these urea groups, there is a group having a polarity exhibiting sufficient compatibility with an organic solvent, which is the dispersion medium 31, and the terminating groups have a polarity exhibiting favorable solubility in regards to the organic solvent that is the dispersion medium 31, for example. This type of modified urea polymer is mainly formed by hydrogen bonding of individual molecules between the urea groups, which forms a three-dimensional polymer network having a three-dimensional mesh structure.

The dispersion liquid 35 having this type of combined rheological control agent exhibits pseudoplastic fluidity and thixotropic characteristics. Thus, this type of rheological control agent contributes as a thixotropic-promoting agent.

The viscosity can be calculated by η=τ/γ, where η is viscosity, γ is shear speed, and τ is shear stress.

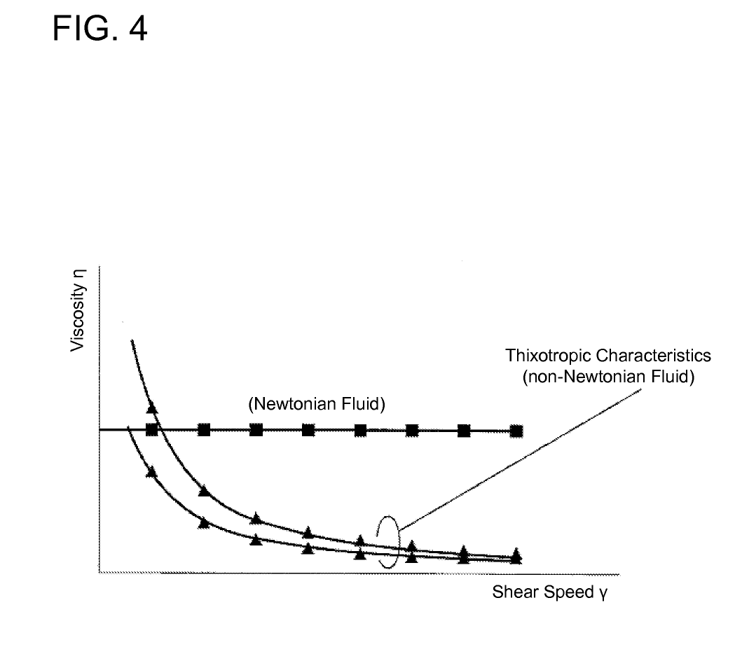

FIG. 4 is a graph showing viscosity curves of a Newtonian fluid, as well as a non-Newtonian fluid exhibiting thixotropic characteristics.

The non-Newtonian fluid (thixotropic fluid) exhibiting thixotropic characteristics shows shear speed dependency and time dependency.

As shown in FIG. 4, the thixotropic fluid, when shear speed is increased, has pseudoplastic behavior (shear thinning). The non-Newtonian fluid exhibiting pseudoplastic behavior has the viscosity thereof decrease when shear stress is high, and increase when shear stress is low.

Furthermore, when shear stress at a constant shear speed is applied to the non-Newtonian fluid exhibiting thixotropic characteristics, the viscosity decreases over time during application of the shear stress. Then, when shear speed becomes zero (γ=0), the recovered viscosity becomes lower than the viscosity during the initial shear thinning, regardless of shear speed. Moreover, there is never an excess thickening effect at γ=0 (rest).

As shown by the modified urea polymer in FIG. 2, when a rheological control agent including a polymer having a structural section with sufficient solubility (compatibility) for the dispersion medium 31 and a structural section that forms a three-dimensional mesh via hydrogen bonding is added to the dispersion medium 31 at a suitable concentration, the polymer almost completely dissolves at the molecular level into the dispersion medium 31 and then associates over time, thereafter precipitating out as crystals (as small needle-like crystalline structures, for example).

At such time, when selecting a polymer having a suitable solubility (suitable insolubility) as the rheological control agent for the dispersion medium 31, as described above, and then dissolving the polymer in the dispersion medium 31, the areas of the polymer with low compatibility with the dispersion medium 31 (areas with association effects, i.e., the urea groups for the polymer shown in FIG. 2) are hardly dissolved in the dispersion medium 31, and the areas of the polymer that are indeed dissolved are dissolved (separated) in a controlled state. As a result, the separated rheological control agent, after being left static for awhile, forms crystals as described above, and then areas with the association effects undergo hydrogen bonding (hydrogen bonding by the urea groups for the polymer shown in FIG. 2) to associate, thereby forming the three-dimensional mesh.

In this manner, the polymer is dissolved into the dispersion medium 31 and then crystalline structures grow over time, thereby forming the three-dimensional mesh as shown in FIG. 3. This increases the viscosity of the dispersion liquid 35. It should be noted that the viscosity at shear speed=0 is not that high and has a certain degree of fluidity.

The three-dimensional mesh described above is easily broken into pieces when shear stress is applied to the dispersion liquid 35. This leads to an expression of thixotropic characteristics and decreases the viscosity of the dispersion liquid 35.

As shown in FIG. 4, the viscosity of the dispersion liquid 35 quickly drops when shear speed is high but gradually increases when shear speed is low. Furthermore, viscosity drops even when time passes at a constant shear speed.

In this manner, when using the rheological control agent described above as the thickening agent 33, it is possible to impart thixotropic characteristics whereby viscosity changes depending on shear stress to the dispersion liquid 35, which includes the rheological control agent.

It should be noted that, as long as the rheological control agent can be almost completely dissolved at the molecular level into the dispersion medium 31 as described above, the rheological control agent may be directly added to the dispersion medium 31, or may be dissolved in a solvent that can completely dissolve the rheological control agent and then added to the dispersion medium 31. In other words, the rheological control agent, as described above, may be solvent based, may be non-solvent based, or may be a liquid. Hereinafter, a material in which an active ingredient of the rheological control agent is dissolved into a solvent is referred to as the “solvent-based rheological control agent,” and is distinct from the rheological control agent (active ingredient) itself. Accordingly, hereinafter, using the solvent-based rheological control agent as the rheological control agent means that the rheological control agent has been dissolved into a solvent, for example.

It is preferable, due to it being possible to easily and uniformly dissolve the rheological control agent, that a solvent-based rheological control agent be used, such solvent-based rheological control agent having a polymer as the solute (primary ingredient; active ingredient) and an organic solvent capable of completely dissolving the polymer as the solvent (prime solvent).

An example of this type of rheological control agent can be a commercially available rheological control agent exhibiting thixotropic characteristics, including a rheological control agent having a crystalline polymer with association effect areas, such as “BYK(registered trademark)-410) (trade name, manufactured by BYK-Chemi Japan, Co., Ltd., solvent-based, primary ingredient: modified urea polymer (52 wt %), primary solvent: NMP), “DISPARLON NVI-8514L” (trade name, manufactured by Kusumoto Chemicals, Ltd., solvent-based, primary ingredient: modified urea polymer (35 wt %), primary solvent: NMP), “DISPARLON GT-1001” (trade name, manufactured by Kusumoto Chemicals, Ltd., solvent-based, primary ingredient: modified urea polymer (35 wt %), primary solvent: NMP), or the like.

It should be noted that the additive amount (amount of active ingredient; in the present example, the amount of polymer added) of the rheological control agent to the dispersion medium 31 is preferably, with respect to the dispersion medium 31 (100 wt %), within the range of 0.01 wt % to 5 wt % of the dispersion medium 31, and even more preferably within the range of 0.05 wt % to 1.0 wt %.

Depending on the type of rheological control agent and shape-anisotropic members 32, if the additive amount of the rheological control agent is less than 0.01 wt %, there is a risk that a three-dimensional polymer network capable of suppressing movement of the shape-anisotropic members 32 during rest thereof will not be able to be formed. On the other hand, depending on the type of rheological control agent, if the additive amount of the rheological control agent exceeds 5 wt %, the content of the rheological control agent in the dispersion liquid 35 will become too high, which could affect transmittance such as by clouding the dispersion liquid 35, or cause a decrease in alignment speed of the shape-anisotropic members 32 in response to applied voltage due to excessive increase in viscosity of the dispersion liquid 35 and an insufficient decrease in the viscosity of the dispersion liquid 35 during voltage driving of the display device 1, or the like. Thus, it is preferable that the additive amount of the rheological control agent ordinarily be within the ranges described above.

(Method of Manufacturing Display Panel 2)

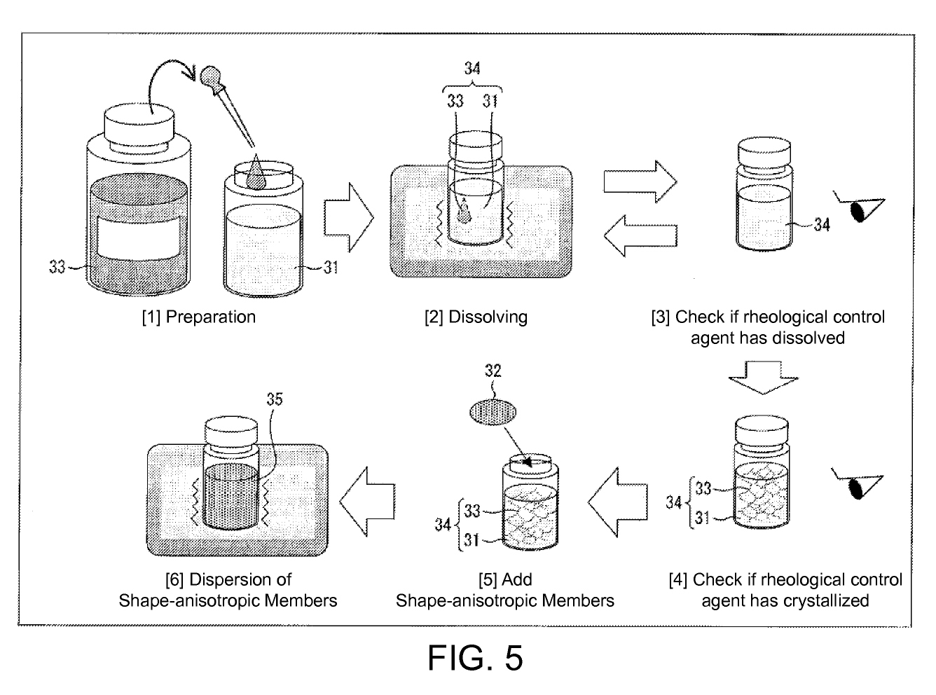

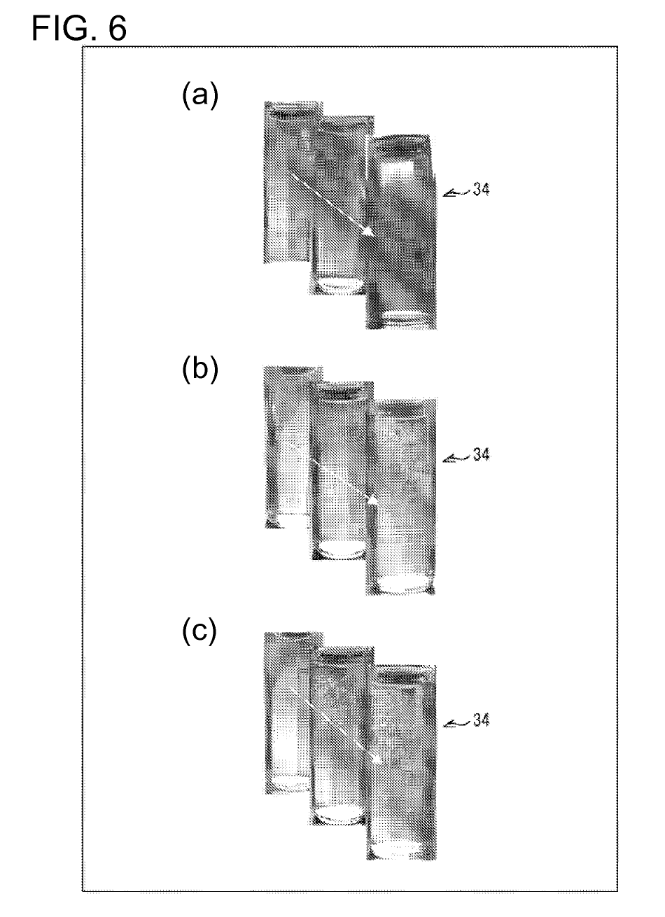

Next, a method of manufacturing the display panel 2 is described. First, a method of preparing the dispersion liquid 35 including, as the thickening agent 33, the organic rheological control agent exhibiting thixotropic characteristics will be described below with FIG. 5 and FIGS. 6(a) to 6(c). The dispersion liquid 35 forms a portion of the light modulation layer 30.

FIG. 5 is a schematic view in step order of a preparation method of the dispersion liquid 35 including, as the thickening agent 33, the organic rheological control agent that expresses thixotropic characteristics.

It should be noted that, in FIG. 5, an example is shown in which the rheological control agent is the solvent-based organic rheological control agent having the polymer with the association effect areas expressing thixotropic characteristics as the solute (prime solute) and an organic solvent capable of completely dissolving the solute.

First, in step [1], the rheological control agent is added to the dispersion medium 31 to prepare a dispersion liquid 34 having the dispersion medium 31 and the rheological control agent (thickening agent 33) exhibiting thixotropic characteristics but not having the shape-anisotropic members 32 (in the present example, this dispersion liquid is made of the dispersion medium 31 and the solvent-based organic rheological control agent exhibiting thixotropic characteristics).

At such time, the solvent-based organic rheological control agent having the polymer with suitable solubility in regards to the dispersion medium 31 of the shape-anisotropic members 32 is selected as described above. Furthermore, at such time, the additive amount of the solvent-based organic rheological control agent is adjusted such that the amount of the polymer (main ingredient), which is the solute in the solvent-based organic rheological control agent, is within the range of 0.01 wt % to 5 wt % with respect to the dispersion medium 31, and more preferably within 0.05 wt % to 1.0 wt % with respect to the dispersion medium 31, as described above.

Next, in step [2], the rheological control agent (polymer) is dissolved in the dispersion medium 31.

The rheological control agent can be dissolved in the dispersion medium 31 by either using various types of stifling devices such as a mixer or dissolver to impart dissolving energy (i.e., rotating the blade of the stirring device at high speeds to impart a large amount of shear stress to the solution) or by using an ultrasonic generator or the like to impart dissolving energy (i.e., imparting dissolving energy with ultrasonic vibration), for example.

It should be noted that the time to impart such dissolving energy has no particular limitations as long as the rheological control agent can be dissolved in the dispersion medium 31, but is 5 to 15 minutes with an ultrasonic generator, for example.

Next, in step [3], a check is performed to ascertain whether the rheological control agent has been dissolved. At such time, if it can be visually confirmed that the dispersion liquid 34 is transparent, the rheological control agent is assumed to have been dissolved in the dispersion medium 31, and the process continues to the next step.

On the other hand, if the dispersion liquid 34 is not transparent, the process returns to step [2]. The shaking of the dispersion liquid 34 in step [2] and the dissolve check in step [3] are repeated until it is confirmed that the dispersion liquid 34 has become transparent in step [3].

Thereafter, in step [4], a crystallization check is performed on the rheological control agent to confirm formation of the three-dimensional mesh structure. The crystallization check of the rheological control agent is performed by leaving the dispersion liquid 34 obtained in step [3] in a static state until it can be confirmed that the crystals (microcrystals) of the rheological control agent are precipitating out.

It should be noted that the precipitation of the rheological control agent crystals is confirmed by leaving the dispersion liquid 34 obtained in step [3] in a static state for several minutes to several days. Furthermore, the crystallization check of the rheological control agent is performed by visual confirmation of the precipitation of the microcrystals or confirming the existence of the crystals through TEM.

As described above, when the organic rheological control agent (polymer) having suitable solubility with respect to the dispersion medium 31 that disperses the shape-anisotropic members 32 is selected and added to the dispersion medium 31 at an appropriate concentration, this organic rheological control agent dissolves in the dispersion medium 31. Thereafter, microcrystals grow in the dispersion medium 31 over time.

FIGS. 6(a) to 6(c) are respective views of pictures showing crystalline growth when the solvent-based rheological control agent exhibiting thixotropic characteristics has been used as the thickening agent 33. It should be noted that FIG. 6(a) is a view when “BYK (registered trademark)-410” has been used as the solvent-based organic rheological control agent, FIG. 6(b) is a view when “NVI-8514L” has been used, and FIG. 6(c) is a view when “GT-1001” has been used.

Furthermore, propylene carbonate at a specific gravity of 1.4 is used for the dispersion medium 31, and aluminum flakes at a specific gravity of 2.7 are used for the shape-anisotropic members 32.

As shown in FIGS. 6(a) to 6(c), when the microcrystals precipitate out, the dispersion liquid 34 either appears slightly milky, or needle-like crystals can be visually confirmed, for example.

Then, if the dispersion liquid 34 with such confirmed crystal precipitation is lightly shook and there is fluidity (namely, if the liquid has not become a gel), then it is determined that the rheological control agent has formed the three-dimensional mesh structure, and the process proceeds to the next step.

Next, in step [5], the shape-anisotropic members 32 are added to the dispersion liquid 34 obtained in step [4]. It should be noted that the shape-anisotropic members 32 may be added in a powder state.

Thereafter, in step [6], the shape-anisotropic members 32 are dispersed in the dispersion liquid 34 by ultrasonic waves, for example. The ultrasonic generator “AS ONE US series” (made by AS ONE Corporation) or the like can be used for dispersion, for example. it should be noted that the dispersion parameters such as shake time and ultrasonic dispersion time have no particular limitations as long as the shape-anisotropic members 32 can be dispersed in the dispersion liquid 34, but is 5 minutes to 15 minutes at 40 kHz when using an ultrasonic generator, for example. This prepares the dispersion liquid 35 including the dispersion medium 31, organic rheological control agent (thickening agent 33), and shape-anisotropic members 32 (in the present example, the dispersion liquid is made of the dispersion medium 31, solvent-based organic rheological control agent, and shape-anisotropic members 32).

The display panel 2 can be manufactured by bonding substrates 10 and 20, which are fabricated using ordinary methods, to each other while ensuring a gap with the dispersion liquid 35 therebetween by using spacers or the like (not shown). The size of the shape-anisotropic members 32 and the spacers are set to respective sizes that do not hinder the alignment operation of the shape-anisotropic members 32 in the dispersion liquid 35.

(Transmittance Control Method)

Next, a method of controlling the transmittance of light with the light modulation layer 30 (a display method of the display panel 2) will be described with reference to FIGS. 1(a) to 1(h), FIGS. 7(a) to 7(d), and FIGS. 9(a) and 9(b).

When the thickening agent 33 is added to the dispersion medium 31, if the shear stress applied to the dispersion liquid 35 is low, the single structures of the thickening agent 33 will weakly bond to one another in the dispersion liquid 35 to form a three-dimensional mesh structure (a three-dimensional polymer network, in the present embodiment).

Thus, as shown in FIG. 1(a), when the flow of the dispersion liquid 35 is low and the shape-anisotropic members 32 are not changing alignment, such as in an initial state (when no voltage is applied), the viscosity of the dispersion liquid 35 increases and temporal movements such as the floating or sinking of the shape-anisotropic members 32 are suppressed, for example.

Next, if a voltage (alternating-current voltage) of a 60 Hz frequency is applied to the light modulation layer 30 as a high-frequency wave, for example, then the shape-anisotropic members 32 will rotate or move such that the long axes thereof become parallel with the lines of electric force, as explained by the dielectrophoresis phenomenon, Coulomb's force, or in terms of electrical energy. In other words, as shown in FIG. 1(b), the shape-anisotropic members 32 align (vertically align) such that the long axes thereof become perpendicular to the substrates 10 and 20. It should be noted that the dispersion liquid 35 will not become excessively thick (relatively little thickening) when shear speed=0 (rest), which makes it possible to hold down the drive voltage to relatively low levels and to avoid an excessive increase in the drive voltage.

At such time, applying the drive voltage to the dispersion liquid 35 as described above will cause shear stress to be applied to the dispersion liquid 35 due to the alignment operation of the shape-anisotropic members 32. As shown in FIG. 1(b), this results in destruction of the three-dimensional mesh of the thickening agent 33, and the single structures of the thickening agent 33 float freely. Thus, during alignment changes of the shape-anisotropic members 32 as described above, the shear stress applied to the dispersion liquid 35 decreases the viscosity of the dispersion liquid 35. Therefore, the thickening agent 33 will never hinder the movement of the shape-anisotropic members 32 caused by an applied voltage. This makes it possible to improve response speed and enable low-voltage driving.

Furthermore, as with the rheological control agent exhibiting thixotropic characteristics, using the thickening agent 33 whereby the three-dimensional mesh structure forms when shear stress is low and is destroyed when shear stress is high makes it possible to maintain the alignment of the shape-anisotropic members 32 during rest time (high viscosity time) of the shape-anisotropic members 32, which makes memory display possible.

In other words, when shear stress is high as shown in FIG. 1(b), the three-dimensional mesh structure is temporarily destroyed, but as shown in FIG. 1(c), when the shear stress being applied to the dispersion liquid 35 is removed by turning OFF the voltage, the shear stress becomes low and the three-dimensional mesh structure recovers over time, as shown in FIG. 1(c) and FIG. 1(d).

As shown in FIG. 1(d), this results in the alignment of the shape-anisotropic members 32 being maintained at voltage OFF, which makes memory display possible.

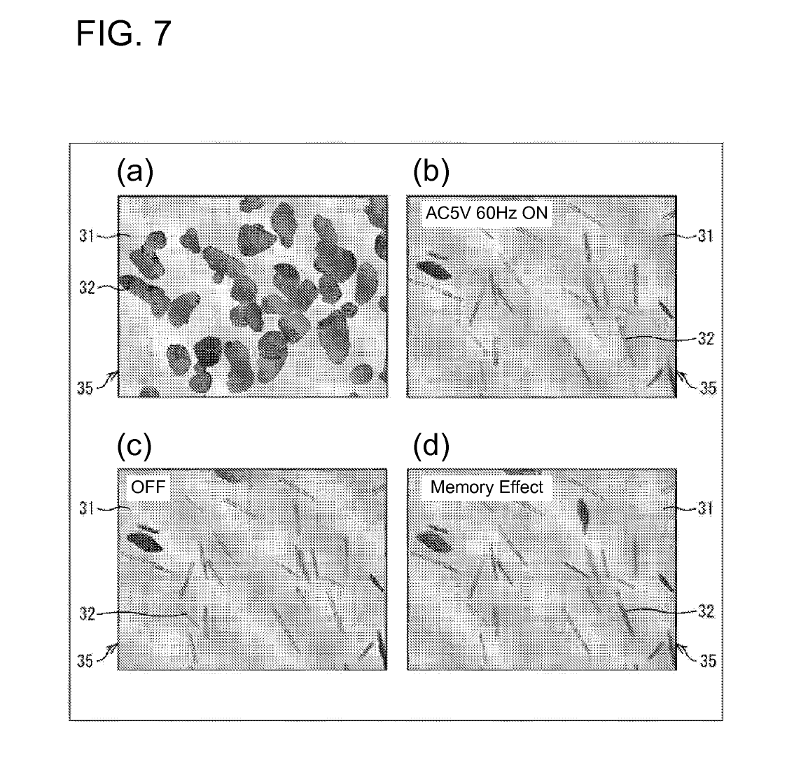

FIGS. 7(a) to 7(d) are photomicrographs showing the dispersion liquid 35, which includes the rheological control agent.

It should be noted that, in this example, the photographs were taken with the solvent-based organic rheological control agent “BYK (registered trademark)-410” as the rheological control agent, propylene carbonate at a specific gravity of 1.4 as the dispersion medium 31, aluminum flakes at a specific gravity of 2.7 as the shape-anisotropic members 32, and a cell thickness of 79 μm.

In this example, FIG. 7(a) shows the state in FIG. 1(a), FIG. 7(b) shows the state in FIG. 1(b), FIG. 7(c) shows the states in FIG. 1(c), and FIG. 7(d) shows the state in FIG. 1(d). It should be noted that the three-dimensional mesh structure of the rheological control agent is in the order of sub-microns, which makes confirmation using the photomicrographs difficult.

As shown in FIG. 7(a), in the initial state (when no voltage is applied) shown in FIG. 1(a), the shape-anisotropic members 32 horizontally align such that the long axes thereof become parallel with the substrates 10 and 20, for example. In this state, if a voltage of 5.0V (alternating-current voltage) is applied at a 60 Hz frequency as a high-frequency wave to the light modulation layer 30 as shown in FIG. 1(b), then, as shown in FIG. 7(b), the shape-anisotropic members 32 vertically align such that the long axes thereof become perpendicular to the substrates 10 and 20.

FIG. 7(c) shows the shape-anisotropic members 32 immediately after voltage has been turned OFF as shown in FIG. 1(c), and FIG. 7(d) shows the shape-anisotropic members 32 after 10 minutes have passed since the voltage has been turned OFF.

It can be understood from FIGS. 7(a) to 7(c) that adding the rheological control agent to the dispersion medium 31 makes voltage driving possible and causes the resulting dispersion liquid 35 to approximately maintain the alignment direction of the shape-anisotropic members 32 and the positions thereof in a plan view even after the voltage is turned OFF (in other words, the dispersion liquid 35 exhibits a memory effect).

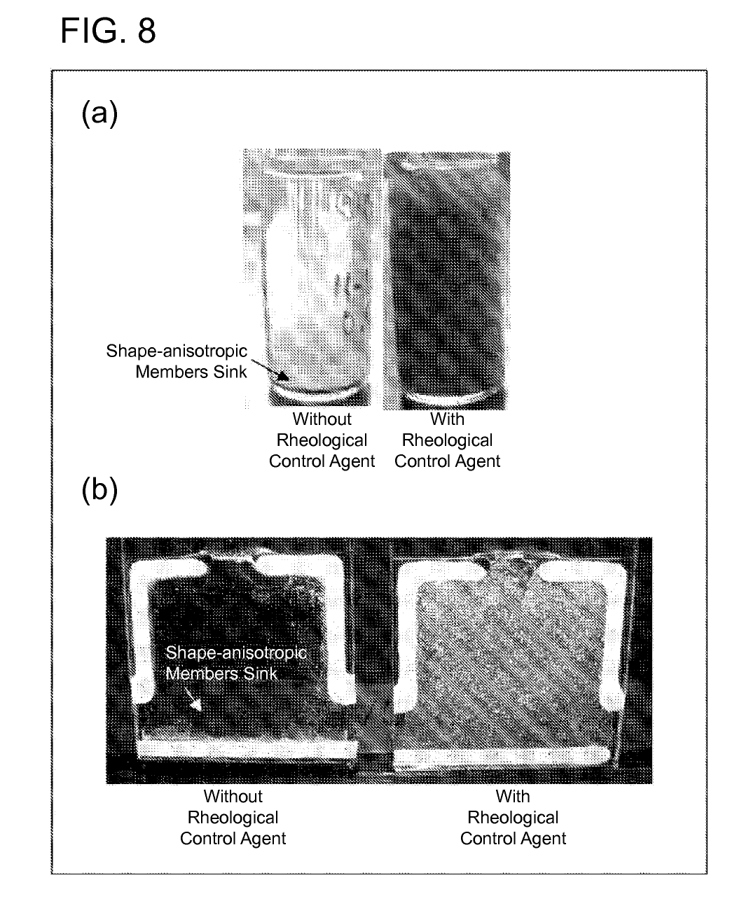

FIGS. 8(a) and 8(b) show the anti-sedimentation effects of the dispersion liquid 35 including the rheological control agent.

In this example, FIGS. 8(a) and 8(b) each show photographs of the shape-anisotropic members 32 when left in a static state for five days after the dispersion liquid 35 has been prepared in differing vessels with the method shown in FIG. 5. For comparison, the respective figures show side-by-side a case in which the rheological control agent has not been added (“without rheological control agent”) and a case in which the rheological control agent has been added (“with rheological control agent”).

It should be noted that a sample tube is used as the vessel in FIG. 8(a) and a standard cell is used as the vessel in FIG. 8(b). Furthermore, as above, the solvent-based organic rheological control agent “BYK (registered trademark)-410” is used as the rheological control agent, propylene carbonate at a specific gravity of 1.4 is used as the dispersion medium 31, and aluminum flakes at a specific gravity of 2.7 are used as the shape-anisotropic members 32.

As a result, without the rheological control agent, all of the shape-anisotropic members 32 sank in several minutes, whereas, after adding the rheological control agent, the shape-anisotropic members 32 did not sink even after five days.

From these results it is understood that adding the rheological control agent makes it possible to prevent in-plane movement and the shape-anisotropic members 32 from floating up or sinking by gravity caused by the difference in specific gravity between the shape-anisotropic members 32 and the dispersion medium 31, which makes memory display possible.

In FIGS. 1(b) to 1(d), an example was described in which memory display is to be performed, but as shown in FIG. 1(e), display may be performed in a state in which a voltage (alternating-current voltage) of a 60 Hz frequency is applied as a high-frequency wave to the light modulation layer 30, for example.

After the alignment operation shown in FIG. 1(b), if the shear stress applied to the dispersion liquid 35 becomes low due to the shape-anisotropic members 32 being at rest, the single structures of the rheological control agent will weakly bond to one another in the dispersion liquid 35, and the destroyed three-dimensional mesh will recover over time, as shown in FIG. 1(e). This makes it possible to increase the viscosity of the dispersion liquid 35 and to maintain the alignment of the shape-anisotropic members 32, which allows for temporal movements such as floating or sinking of the shape-anisotropic members 32 to be suppressed.

In this manner, the thickening agent 33 functions as a movement suppressor that suppresses the movement of the shape-anisotropic members 32 when the shear stress applied to the dispersion liquid 35 is low. Thus, applying the thickening agent 33 to the dispersion medium 31 makes it possible to prevent floating or sinking by gravity of the shape-anisotropic members 32 caused by the difference in specific gravity between the shape-anisotropic members 32 and the dispersion medium 31. Therefore, it is possible to prevent deviations of the shape-anisotropic members 32 in the light modulation layer 30 and to enable voltage driving operation of the shape-anisotropic members 32.

When the shape-anisotropic members 32 are vertically aligned as shown in FIG. 1(d) or FIG. 1(e), the light that has entered the light modulation layer 30 from the backlight 3 passes through the light modulation layer 30 (direct transmission, for example) and exits to the viewer's side.

It should be noted that, at such time, if a material that reflects visible light such as aluminum flakes is used as the shape-anisotropic members 32, then these members vertically aligning such that the reflective plane is perpendicular to the substrates 10 and 20 will cause the light that has entered the light modulation layer 30 to pass directly therethrough or reflect at the reflective surfaces of the shape-anisotropic members 32 and then pass through to the surface opposite to the light-incident side, i.e., the display surface side, for example.

When the shape-anisotropic members 32 are vertically aligned in this manner, the light that has entered the light modulation layer 30 from the backlight 3 passes through the light modulation layer 30 and exits to the viewer's side, thereby making white display possible during transmissive display.

Furthermore, if a voltage with a frequency of 0.1 Hz or a direct-current voltage (frequency=0 Hz) is applied as a low-voltage wave to the light modulation layer 30, then as shown in FIG. 1(f), the shape-anisotropic members 32 that have charge will be attracted towards the electrode having a charge of the opposite polarity thereto, due electrophoretic force, Coulomb's force, or the like. The shape-anisotropic members 32, in order to have the most stable alignment, will rotate or move to attach to the substrates 10 or 20 (substrate 20 in the example shown in FIG. 1(f)).

It should be noted that, at such time, applying a drive voltage to the dispersion liquid 35 as described above will cause shear stress to be applied to the dispersion liquid 35 due to the alignment operation of the shape-anisotropic members 32. As shown in FIG. 1(f), this results in destruction of the three-dimensional mesh of the thickening agent 33, and the single structures of the thickening agent 33 float freely. Thus, shear stress being applied to the dispersion liquid 35 causes the viscosity of the dispersion liquid 35 to decrease even during alignment change of the shape-anisotropic members 32. Therefore, the thickening agent 33 will never hinder the movement of the shape-anisotropic members 32 caused by an applied voltage. This makes it possible to improve response speed and enable low-voltage driving.

As above, when shear stress is high as shown in FIG. 1(f), the three-dimensional mesh structure is temporarily destroyed, but after the alignment operation in FIG. 1(f), when the shear stress applied to the dispersion liquid 35 becomes low due to the shape-anisotropic members 32 being at rest, the single structures of the rheological control agent form weak bonds to one another in the dispersion liquid 35 and the destroyed three-dimensional mesh recovers over time, as shown in FIG. 1(g). This makes it possible to increase the viscosity of the dispersion liquid 35 and to maintain the alignment of the shape-anisotropic members 32, which allows for temporal movements such as floating or sinking of the shape-anisotropic members 32 to be suppressed.

Although not shown in the drawings, as above, if the voltage is turned OFF after the alignment operation in FIG. 1(f) to remove the shear stress applied to the dispersion liquid 35, the shear stress becomes low and the three-dimensional mesh structure recovers over time, thereby maintaining the alignment of the shape-anisotropic members 32 when the voltage is OFF. This makes memory display possible.

It should be noted that, in FIG. 1(f) and FIG. 1(g), an example is shown in which, when a direct-current voltage is applied to the light modulation layer 30, the polarity (positive) of the charge of the electrode 22 of the substrate 20 differs from the polarity (negative) of the charge of the shape-anisotropic members 32, and the shape-anisotropic members 32 are aligned so as to attach to the substrate 20. In other words, the shape-anisotropic members 32 are aligned (horizontally aligned) such that the long axes thereof become parallel with the substrates 10 and 20.

As a result, the light that has entered the light modulation layer 30 from the backlight 3 is blocked by the shape-anisotropic members 32, and thus does not pass through (is not transmitted by) the light modulation layer 30. This causes black display to be performed.

In terms of thickness, the thinner the shape-anisotropic members 32 are, the more that ambient light scattering can be reduced due to fewer recesses and protrusions in the display surface side of the overlapping shape-anisotropic members. Therefore, the thinner the shape-anisotropic members 32 are, the higher the transmittance that can be obtained and the less scattering there will be for black display. Accordingly, it is preferable that the thickness of the shape-anisotropic members 32 be at the wavelength of light or below (0.5 μm or below, for example), regardless of shape. When using flakes as the shape-anisotropic members 32 as described above, it is preferable that the thickness thereof be 1 μm or less, and even more preferable that the thickness be 0.1 μm or less.

In this manner, it is possible to cause the transmittance of light that has entered the light modulation layer 30 from the backlight 3 to change by switching the voltage applied to the light modulation layer 30 between direct current (i.e., a frequency of 0) and alternating current, or by switching between a low-frequency alternating current and a high-frequency alternating current.

The frequency when the shape-anisotropic members 32 horizontally align (when switching to horizontal alignment) is 0 Hz to 0.5 Hz, for example, and the frequency when the shape-anisotropic members 32 vertically align (when switching to vertical alignment) is 30 Hz to 1 kHz, for example.

These frequencies are set in advance based on the shape and material of the shape-anisotropic members 32, thickness (cell thickness) of the light modulation layer 30, and the like. In other words, in the display device 1, the transmittance of light is changed by switching the frequency of the voltage applied to the light modulation layer 30 between a low frequency that is at a first threshold or below and a high frequency that is at a second threshold or higher. In this example, the first threshold can be set to 0.5 Hz and the second threshold can be set to 30 Hz, for example.

It should be noted that, in FIG. 1(g), the minus side of the power supply 41 is connected to the electrodes 12 and the plus side is connected to the electrode 22, but the present invention is not limited to this, and, as shown in FIG. 1(h), the minus side may connect to the electrode 22 and the plus side may connect to the electrodes 12. In other words, FIG. 1(h) shows a case in which the polarity of the direct-current voltage has been reversed from that shown in FIG. 1(g). In the configuration of FIG. 1(h), the shape-anisotropic members 32 align so as to attach to the substrate 10. Furthermore, in FIGS. 1(a) to 1(h), an example is shown in which the polarity of the charge of the shape-anisotropic members 32 is negative, but the present invention is not limited to this, and the polarity of the charge of the shape-anisotropic members 32 may be positive. In such a case, as shown in FIG. 9(a) and FIG. 9(b), the substrate to which the shape-anisotropic members 32 attach is the opposite of the one shown in FIG. 1(g) and FIG. 1(h).

(Effects)

As described above, according to the present embodiment, the dispersion liquid 35 having the thickening agent 33 that changes the viscosity of the dispersion liquid 35 in response to shear stress makes it possible to increase viscosity of the dispersion liquid 35 when the shear stress applied thereto is low and to suppress deviations of the shape-anisotropic members 32 such as floating, sinking, in-plane movement, or the like. In addition, during alignment change of the shape-anisotropic members 32, the shear stress applied to the dispersion liquid 35 becomes high and reduces the viscosity of the dispersion liquid 35 but does not hinder movement of the shape-anisotropic members 32. Thus, the present embodiment makes it possible to prevent display anomalies caused by deviations of the shape-anisotropic members 32 without hindering drive performance to the greatest extent possible. Moreover, the present embodiment allows for memory display that maintains alignment while the shape-anisotropic members 32 are at rest, as described above.

Furthermore, when the thickening agent 33 exhibiting thixotropic characteristics is used, thixotropic characteristics can be imparted to the dispersion liquid 35. The dispersion liquid 35 exhibiting thixotropic characteristics does not excessively thicken (relatively little thickening) the liquid when shear speed=0 (during rest), as described above. Therefore, when using the thickening agent 33 exhibiting thixotropic characteristics, it is possible to hold the drive voltage to a relatively low level and to prevent excessive increases of the drive voltage.

### Embodiment 2

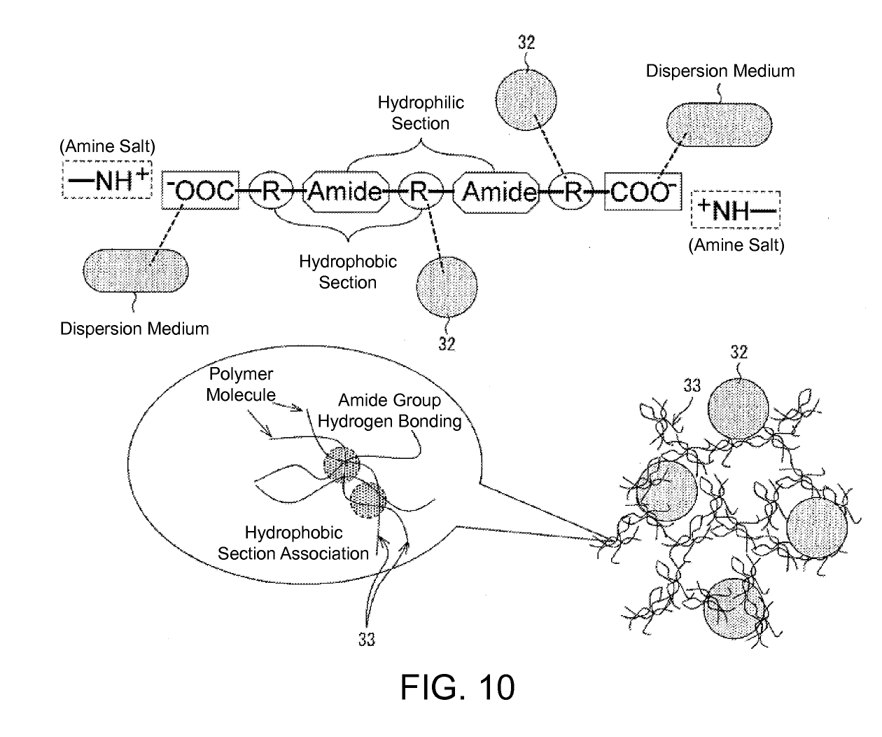

Another embodiment according to the present invention is described below with reference to FIGS. 10 to 12. For ease of explanation, the constituting components having the same functions as those described in Embodiment 1 above are given the same reference characters, and the descriptions thereof are omitted. In the present embodiment, differences between Embodiment 1 and Embodiment 2 will be explained.

(Thickening Agent 33)

In Embodiment 1, examples were described in which a rheological control agent exhibiting thixotropic characteristics was mainly used as the thickening agent 33. In the present embodiment, of the thickening agents 33 described in Embodiment 1, the rheological control agent exhibiting pseudoplasticity is used as the thickening agent 33.

The rheological control agent exhibiting pseudoplasticity is an associated organic rheological control agent including a crystalline polymer having areas with association effects, for example.

Furthermore, the selected rheological control agent has suitable solubility with respect to the dispersion medium 31 of the shape-anisotropic members 32. The areas with association effects in the selected rheological control agent have low solubility with respect to the dispersion medium 31.

FIG. 10 is a schematic view showing the three-dimensional polymer network used as the organic rheological control agent expressing pseudoplasticity alongside one example of the chemical structure of the polymer.

The polymer includes amide groups having the chemical structure shown in FIG. 10. As shown in FIG. 10, the polymer having the amide groups in the molecules expresses thickening effects by amide bonding.

Furthermore, as shown in FIG. 10, the polymer has a hydrophilic portion and a hydrophobic portion in a single molecule, and the hydrophilic portion is at the terminating end of the polymer, for example. The hydrophilic portion at the terminating end of the polymer acts on the dispersion medium 31 and is dissolved in the dispersion medium 31. Thus, the polymer exhibits a sufficient level of solubility in regards to the dispersion medium 31. Meanwhile, the hydrophobic portion of the polymer main chain has strong interaction at the hydrophobic portion between the polymers or with the shape-anisotropic members 32 having a hydrophobic surface, and associates thereby.

This type of polymer has a succession of basic units in which associated polymer chains are intertwined together to create a three-dimensional mesh as shown in FIG. 10 and to hold the shape-anisotropic members 32 in this three-dimensional mesh.

The basic units in which associated polymer chains are intertwined together are not easily dissolved, but the three-dimensional mesh can be broken into pieces by shear stress.

If this type of rheological control agent is added to the dispersion medium 31, pseudoplasticity will be exhibited, and the dispersion medium 31 in which the rheological control agent is blended will exhibit pseudoplastic fluidity. Therefore, this type of rheological control agent contributes as a pseudoplasticity-promoting agent.

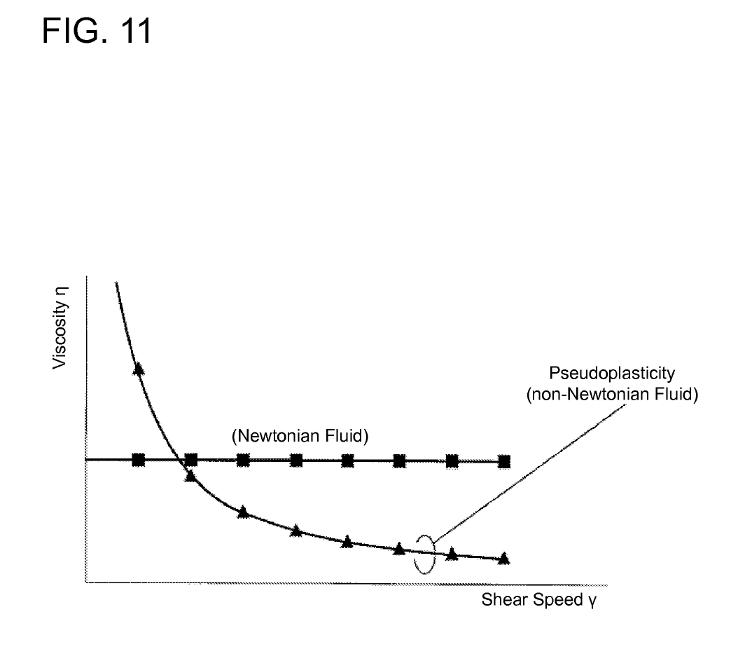

FIG. 11 is a graph showing the viscosity curve of a non-Newtonian fluid exhibiting pseudoplasticity.

The pleudoplastic fluid is a non-Newtonian fluid that exhibits shear speed dependency but not time dependency, and the viscosity decreases as shear stress increases. As shown in FIG. 11, when shear speed is increased, the pseudoplastic fluid exhibits pseudoplastic behavior and viscosity drops when shear stress increases, whereas viscosity increases when shear stress decreases.

The pseudoplastic fluid, however, differs from the thixotropic fluid described in Embodiment 1 in that the viscosity when shear speed is zero (γ=0) is very high with almost no fluidity, but once shear speed is above 0 (γ>0), the viscosity rapidly drops. Furthermore, in the case of the pseudoplastic fluid, a certain viscosity is exhibited at a certain shear speed and, at a certain shear speed, viscosity does not decrease over time as with the thixotropic fluid.

It should be noted that, as described above, the rheological control agent exhibiting pseudoplasticity may be solvent-based, non-solvent based, or a liquid, but it is preferable to use a solvent-based rheological control agent because the agent can be easily and uniformly dissolved.

An example of this type of rheological control agent can be a commercially available solvent-based rheological control agent exhibiting pseudoplasticity, including a rheological control agent having a crystalline polymer with association effect areas as the prime ingredient, such as “BYK(registered trademark)-430) (trade name, manufactured by BYK-Chemi Japan, Co., Ltd., solvent-based, primary ingredient: modified urea polymer (30 wt %), primary solvent: isobutyl alcohol (62.5 wt %) and solvent naphtha (7 wt %), “DISPARLON AQ-600” (trade name, manufactured by Kusumoto Chemicals, Ltd., solvent-based, primary ingredient: polyamide amine base (20 wt %), primary solvent: propylene glycol monomethyl ether (7.0 wt %) and water (71.1 wt %), “DISPARLON AQH-800” (trade name, manufactured by Kusumoto Chemicals, Ltd., solvent-based, primary ingredient: polyamide amine base and fatty acid amide (approx. 10 wt %), primary solvent: propylene glycol monomethyl ether (5.5 wt %), or the like.

It should be noted that the additive amount (amount of active ingredient; in the present example, the amount of polymer added) of the rheological control agent to the dispersion medium 31 is preferably, with respect to the dispersion medium 31, within the range of 0.01 wt % to 5 wt % of the dispersion medium 31, and more preferable within the range of 0.05 wt % to 1.0 wt %, which is the same as Embodiment 1 and for the same reasons as Embodiment 1.

(Method of Preparing Dispersion Liquid 35)

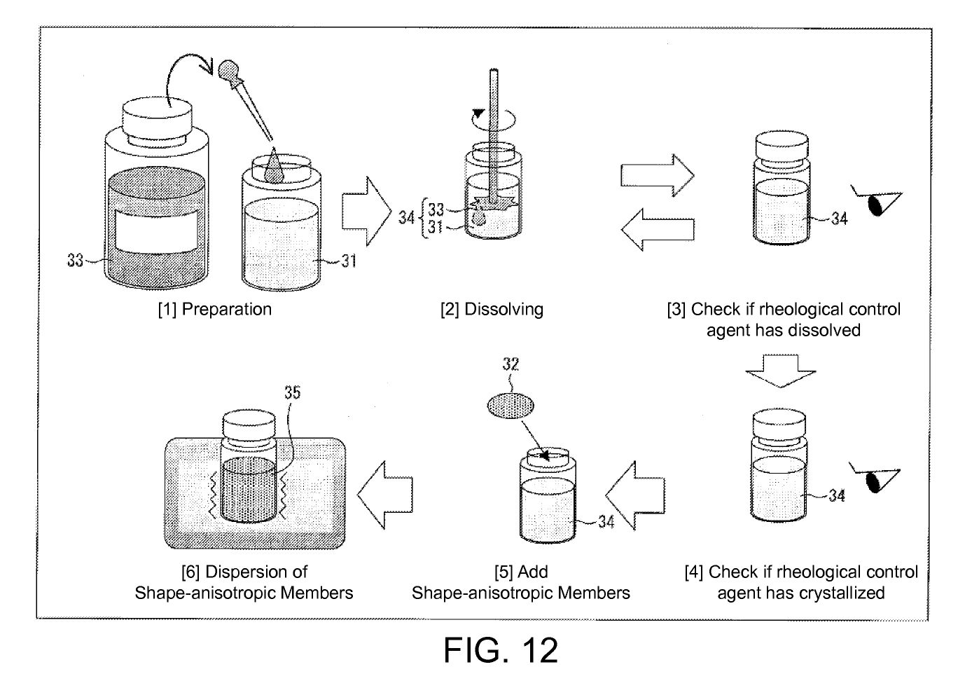

Next, the method of preparing the dispersion liquid 35 using the rheological control agent exhibiting pseudoplasticity for the display panel 2 is described below using FIG. 12.

FIG. 12 is a schematic view in step order of a preparation method of the dispersion liquid 35 as the thickening agent 33, the dispersion liquid having the organic rheological control agent that exhibits pseudoplasticity.

It should be noted that, in FIG. 12, an example is shown in which the rheological control agent is the solvent-based organic rheological control agent having the polymer with the association effect areas expressing pseudoplasticity as the solute (prime solute) and an organic solvent capable of completely dissolving the solute.

In the present embodiment, in step [1], the rheological control agent is added to the dispersion medium 31 to prepare a dispersion liquid 34 having the dispersion medium 31 and the rheological control agent (thickening agent 33) exhibiting pseudoplasticity but not having the shape-anisotropic members 32 (in the present example, this dispersion liquid is made of the dispersion medium 31 and the solvent-based organic rheological control agent exhibiting pseudoplasticity).

At such time, the solvent-based organic rheological control agent (main ingredient) having the polymer with suitable solubility in regards to the dispersion medium 31 of the shape-anisotropic members 32 is selected as described above. Furthermore, at such time, the additive amount of the solvent-based organic rheological control agent is adjusted such that the amount of the polymer (main ingredient), which is the solute in the solvent-based organic rheological control agent, is within the range of 0.01 wt % to 5 wt % with respect to the dispersion medium 31, and more preferably within 0.05 wt % to 1.0 wt % with respect to the dispersion medium 31, as described above.

Next, as above, in step [2] of the present embodiment, the rheological control agent (polymer) is dissolved in the dispersion medium 31. The dissolving method and dissolving measures can be similar to the method and measures used in Embodiment 1. In FIG. 12, an example is shown in which a stirring device is used to stir the dispersion liquid 34 to dissolve the rheological control agent in the dispersion medium 31.

The stirring time in this case has no particular limitations as long as the rheological control agent is dissolved in the dispersion medium 31, but is approximately five minutes at 500 rpm to 20 minutes at 2000 rpm when using a dissolver as the stirring device, for example.

It should be noted that, in the same manner as Embodiment 1, an ultrasonic generator or the like may be used to impart ultrasonic vibration to the dispersion liquid 34 to dissolve the rheological control agent in the dispersion medium 31, and the shake time in this case should be long enough to dissolve the rheological control agent in the dispersion medium 31. A rough amount of time to use in this case is 5 to 15 minutes, as described in Embodiment 1, for example.

Next, as above, in step [3] of the present embodiment, a check is performed to ascertain whether the rheological control agent has been dissolved. When using the organic rheological control agent described above as the rheological control agent, if it can be visually confirmed that the dispersion liquid 34 is milky and uniform, then it is assumed that the rheological control agent has been dissolved in the dispersion medium 31, and the process proceeds to the next step.

On the other hand, if the rheological control agent completely separates from the dispersion medium 31, it is assumed that the rheological control agent has not been dissolved in the dispersion medium 31, and the process returns to step [2]. In the present embodiment, as above, step [2] and step [3] are repeated until it is confirmed that the rheological control agent has dissolved in the dispersion medium 31 in step [3].

Thereafter, in the present embodiment, as above, in step [4], a crystallization check is performed on the rheological control agent to confirm formation of the three-dimensional mesh structure. The crystallization check of the rheological control agent is performed by leaving the dispersion liquid 34 obtained in step [3] in a static state until it can be confirmed that the crystals (microcrystals) of the rheological control agent are precipitating out.

It should be noted that the precipitation of the rheological control agent crystals is confirmed by leaving the dispersion liquid 34 obtained in step [3] in a static state for several minutes to several days.

At such time, the viscosity while the dispersion liquid 34 in step [4] is at rest is higher than the viscosity of the dispersion liquid 34 in step [3], and if the dispersion liquid 34 is lightly shook and there is fluidity (namely, if the liquid has not become a gel), then it is determined that the rheological control agent has formed the three-dimensional mesh structure, and the process proceeds to the next step.

Next, in step [5] and step [6], a similar process to that in step [5] and step [6] in Embodiment 1 is performed to prepare a dispersion liquid 35 having the dispersion medium 31, the rheological control agent (thickening agent 33), and the shape-anisotropic members 32 (in the present example, this dispersion liquid is made of the dispersion medium 31, the solvent-based organic rheological control agent, and the shape-anisotropic members 32).

(Transmittance Control Method)

The change in viscosity in relation to shear speed of the dispersion liquid 35 obtained in this manner is the same as the dispersion liquid 35 using the rheological control agent expressing thixotropic characteristics except for the behavior shown in FIG. 11, rather than FIG. 4.

Accordingly, the method of controlling transmittance of the display panel 2 in the present embodiment (the display method of the display panel 2) is the same as in Embodiment 1. Therefore, descriptions thereof will be omitted.

(Effects)

According to the present embodiment, as described above, selecting a rheological control agent exhibiting pseudoplasticity and having suitable solubility with respect to the dispersion medium 31 including the shape-anisotropic members 32 and adding this agent to the dispersion medium 31 at an appropriate concentration partially dissolves the terminating ends of the rheological control agent (polymer molecules) into the dispersion medium 31 while the main chains of the rheological control agent (polymer molecules) directly interact with parts of the surfaces of the shape-anisotropic members 32 to form the three-dimensional mesh structure. This results in an increase in the viscosity of the dispersion medium 31 (viscosity of the dispersion liquid 35). If shear stress is applied to the dispersion liquid 35 by the alignment operation of the shape-anisotropic members 32 in this state, the three-dimensional mesh structure is destroyed and the viscosity of the dispersion medium 31 (viscosity of the dispersion liquid 35) drops. The shape-anisotropic members 32 being at rest causes the dispersion liquid 35 to be at rest (i.e., to stop flowing), which allows the three-dimensional mesh structure to be rebuilt, thereby increasing viscosity.

Therefore, the present embodiment can also achieve similar effects to that of Embodiment 1. In addition, as described above, as a thickening agent 33, the dispersion liquid 35 including the rheological control agent exhibiting pseudoplasticity differs from the rheological control agent exhibiting thixotropic characteristics in that the viscosity when shear speed is zero (i.e., when no voltage is being applied and the shape-anisotropic members 32 are at rest) is markedly high (there is almost no fluidity). Therefore, the thickening of the dispersion liquid 35 when the shape-anisotropic members 32 are at rest is greater than if the rheological control agent exhibiting thixotropic characteristics were used, which allows for favorable memory properties. Moreover, using the rheological control agent exhibiting pseudoplasticity as the thickening agent 33 differs from using the rheological control agent exhibiting thixotropic characteristics in that the viscosity to shear speed values are fixed. Thus, this facilitates the design of voltage drive control more than if the rheological control agent exhibiting thixotropic characteristics were used.

### Embodiment 3

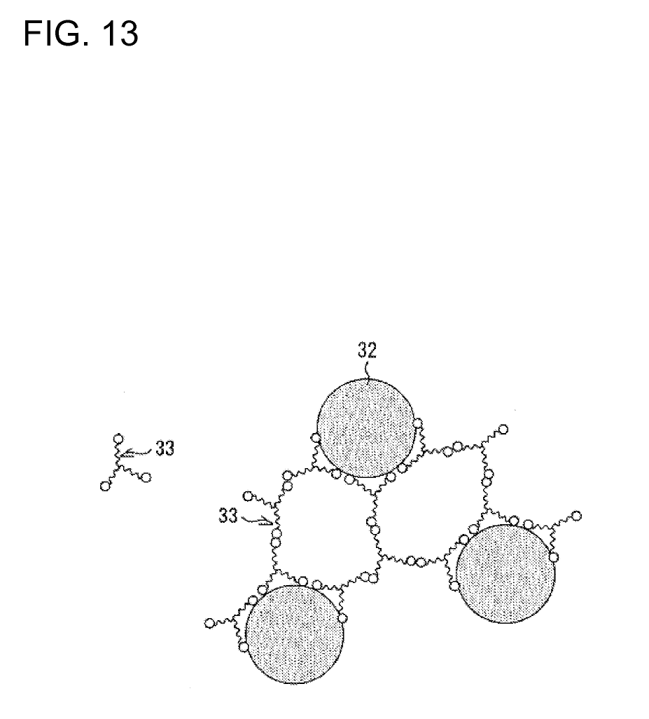

Another embodiment according to the present invention is as described below with reference to FIG. 13. For ease of explanation, the constituting components having the same functions as those described in Embodiments 1 and 2 above are given the same reference characters, and the descriptions thereof are omitted. In the present embodiment, differences between Embodiment 1 and Embodiment 2 will be explained.

(Thickening Agent 33)

In Embodiment 1, an example was described n which the thickening agent 33 was a wetting & dispersant agent.

A wetting & dispersant agent is a substance that lowers the contact angles between the dispersion medium and the dispersed material. A wetting & dispersant agent is normally used as an anti-pigment aggregation agent and exhibits similar effects to a rheological control agent.

An association-type polymer including a crystalline polymer having association effect areas is used as the wetting & dispersant agent, for example. Furthermore, the polymer has a hydrophilic portion and a hydrophobic portion in a single molecule, for example. Therefore, the polymer exhibits suitable solubility with respect to the dispersion medium 31, while the hydrophobic portion of the polymer main chain has strong interaction at the hydrophobic portion between the polymers or with the shape-anisotropic members 32 having a hydrophobic surface, and associates thereby.

FIG. 13 is a schematic view of a three-dimensional network of the wetting & dispersant agent.

As shown in FIG. 13, the wetting & dispersant agent is adsorbed onto the shape-anisotropic members 32 to prevent aggregation of the shape-anisotropic members 32, and the association effect areas associate through hydrogen bonding to form a three-dimensional mesh structure, for example. This results in weak thixotropic characteristics. Accordingly, the wetting & dispersant agent also contributes as a thixotropic-promoting agent.

It should be noted that the wetting & dispersant agent may be solvent-based, non-solvent based, or a liquid.

An example of the wetting & dispersant agent can be a commercially available wetting & dispersant agent, such as: “BYK(registered trademark)-P104” (trade name, manufactured by BYK-Chemi Japan, Co., Ltd., solvent-based, primary ingredient: unsaturated polycarboxylic acid polymer (50 wt %), primary solvent: xylene (31.7 wt %), ethyl benzene (13 wt %), and diisobutyl ketone (5.0 wt %); “BYK(registered trademark)-P104S” (trade name, manufactured by BYK-Chemi Japan, Co., Ltd., solvent-based, primary ingredient: unsaturated polycarboxylic acid polymer and polysiloxane copolymer (50 wt %), primary solvent: xylene (31.6 wt %), ethyl benzene (13 wt %), and diisobutyl ketone (5.0 wt %); “BYK(registered trademark)-P105” (trade name, manufactured by BYK-Chemi Japan, Co., Ltd., non-solvent based, primary ingredient: unsaturated polycarboxylic acid polymer (100 wt %); “ANTI-TERRA(registered trademark)-203” (trade name, manufactured by BYK-Chemi Japan, Co., Ltd., solvent-based, primary ingredient: polycarboxylic acid alkylammonium salt (52.0 wt %), primary solvent: solvent naphtha (48.0 wt %); “ANTI-TERRA(registered trademark)-204” (trade name, manufactured by BYK-Chemi Japan, Co., Ltd., solvent-based, primary ingredient: polyaminoamide polycarboxylate (52.0 wt %), primary solvent: propylene glycol monomethyl ether (30 wt %) and solvent naphtha (18.0 wt %); “ANTI-TERRA(registered trademark)-205” (trade name, manufactured by BYK-Chemi Japan, Co., Ltd., solvent-based, primary ingredient: polyaminoamide polycarboxylate (52.0 wt %), primary solvent: propylene glycol monomethyl ether (30 wt %) and petroleum naphtha (18.0 wt %); or the like.

The additive amount of the wetting & dispersant agent with respect to the dispersion medium 31 and the method of preparing the dispersion liquid 35 using the wetting & dispersant agent for the display panel 2 is the same as in Embodiment 1.

(Effects)

In the present embodiment too, the wetting & dispersant agent (polymer) builds a three-dimensional mesh structure when the dispersion liquid 35 is not flowing (when shear stress is low), whereas shear stress being applied to the dispersion liquid 35 through alignment operation of the shape-anisotropic members 32 causes the dispersion liquid 35 to flow and the three-dimensional mesh structure to be destroyed, thereby lowering the viscosity of the dispersion medium 31 (the viscosity of the dispersion liquid 35). When the dispersion liquid 35 is at rest (i.e., not flowing) due to the shape-anisotropic members 32 being at rest, the three-dimensional mesh structure is rebuilt and viscosity increases. Therefore, the present embodiment can also achieve similar effects to that of Embodiment 1.

It should be noted that, as described above, the dispersion liquid 35 that includes the wetting & dispersant agent as the thickening agent 33 has low suppressing effects of deviations of the shape-anisotropic members 32 such as floating or sinking of the shape-anisotropic members 32 or in-plane movement and also has low memory-contributing effects, but the increase is viscosity is low, which makes it possible to hold the drive voltage of the shape-anisotropic members 32 at a low level.

Furthermore, according to the present embodiment, as described above, the wetting & dispersant agent is adsorbed onto the shape-anisotropic members 32 to prevent aggregation of the shape-anisotropic members 32; thus, the shape-anisotropic members 32 do not aggregate and are in state whereby the members are markedly easy to loosen. Therefore, by being combined with a suitable drive method that effectively shakes the dispersion liquid 35 injected in the cell interior of the display panel (between the substrates 10 and 20), a swelling dispersant agent can return the dispersion medium 31 to a stable dispersed state as needed.

### Embodiment 4

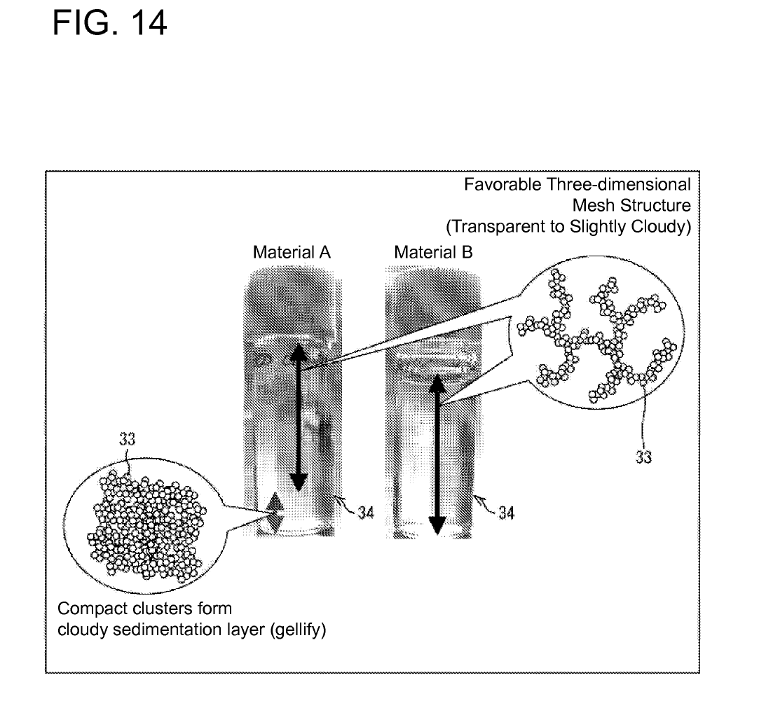

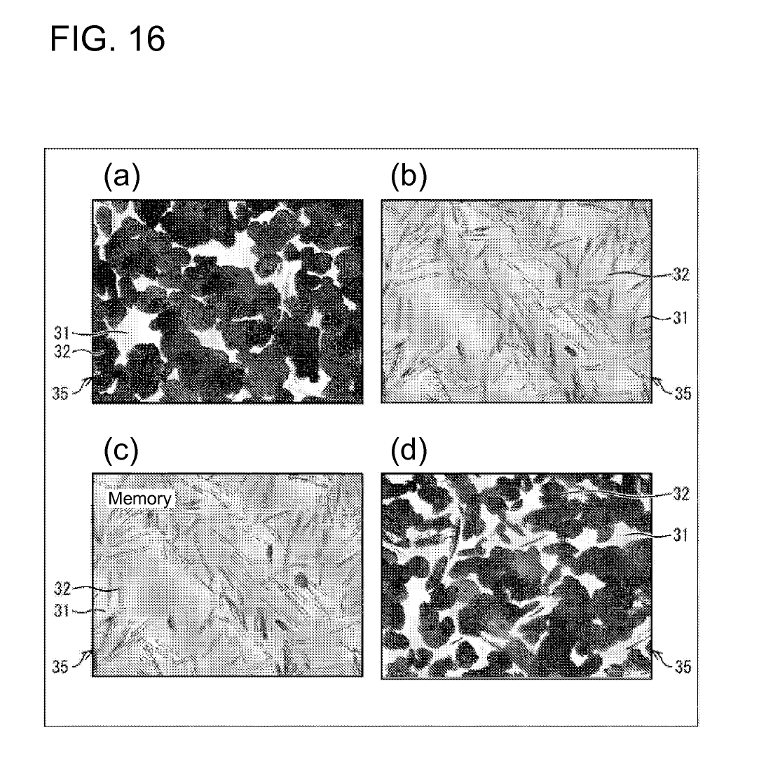

Another embodiment of the present invention is described as follows with reference to FIG. 14 and FIGS. 16(a) to 16(d). For ease of explanation, the constituting components having the same functions as those described in Embodiments 1 to 3 above are given the same reference characters, and the descriptions thereof are omitted. In the present embodiment, differences among Embodiments 1 to 3 will be explained.

(Thickening Agent 33)

In the present embodiment, an example will be described in which the thickening agent 33 is an inorganic nanoparticle rheological control agent, which is one type of inorganic rheological control agent exhibiting thixotropic characteristics.

The principles behind rheological control with an inorganic nanoparticle rheological control agent is the same as the organic rheological control agent in Embodiment 1, and, in a similar manner to the organic rheological control agent, the inorganic nanoparticle rheological control agent has the thixotropic characteristics shown in FIG. 4.

Unlike the organic rheological control agent, however, no chemical changes occur during rebuilding of the three-dimensional mesh structure, and when the three-dimensional mesh structure is being built, a natural aggregating phenomenon of the inorganic nanoparticle rheological control agent particles (microparticles) is used.

The inorganic nanoparticle rheological control agent is manufactured by dry high-temperature firing, for example, and thus has a markedly low amount of impurities. Therefore, there is a low amount of contamination (introduction of impurities) of the dispersion medium 31 caused by adding the rheological control agent to the dispersion medium 31 (introduction to the dispersion liquid 35), and few risk factors for drops in reliability such as electrolysis during voltage driving of the shape-anisotropic members 32. Furthermore, the inorganic nanoparticle rheological control agent differs from the organic rheological control agent in that, when modifying the dispersion medium 31 of the dispersion liquid 35, only the surface treatment state of the inorganic nanoparticle rheological control agent particles (inorganic nanoparticles) need be modified to control aggregability, and thus there are more advantages than for the organic rheological control agent, such as a higher degree of freedom when selecting materials.

Inorganic nanoparticles such as silica nanoparticles are used for the inorganic nanoparticle rheological control agent, for example. It should be noted that ultrapure silica nanoparticles made by dry high-temperature firing would be used for these silica nanoparticles, for example.

An example of the inorganic nanoparticle rheological control agent can be a commercially inorganic nanoparticle rheological control agent, such as: “AEROSIL(registered trademark)-300” (trade name, manufactured by NIPPON AEROSIL CO., LTD., powder, hydrophilic (untreated surface) fumed silica, primary particle diameter 7 nm); “AEROSIL(registered trademark)-R976” (trade name, manufactured by NIPPON AEROSIL CO., LTD., powder, hydrophobic treated (dimethylsilane) fumed silica, primary particle diameter 7 nm); “AEROSIL(registered trademark)-R976S” (trade name, manufactured by NIPPON AEROSIL CO., LTD., powder, high-density hydrophobic treated (dimethylsilane) fumed silica, primary particle diameter 7 nm); “AEROSIL(registered trademark)-RX300” (trade name, manufactured by NIPPON AEROSIL CO., LTD., powder, highly hydrophobic treated (dimethylsilane) fumed silica, primary particle diameter 7 nm); or the like.

These rheological control agents use the cohesion power of the silica nanoparticles to form a mesh-like aggregated structure by the aggregates successively joining together, with each aggregate being several dozen to several hundred nm and having a primary particle diameter of several nm. Furthermore, these rheological control agents have silica inorganic particles as the basic units thereof, and thus form a rigid three-dimensional mesh structure. In a similar manner to the organic rheological control agent, however, when shear stress is applied, the three-dimensional mesh structure is destroyed.

When using the inorganic nanoparticle rheological control agent as the thickening agent 33 in this manner, the additive amount of the inorganic nanoparticle rheological control agent with respect to the dispersion medium 31 is preferably, if the weight of the dispersion medium 31 is 100 wt %, within the range of 0.05 wt % to 10 wt %, and even more preferably within the range of 0.5 wt % to 3.0 wt %.

Depending on the type of rheological control agent and shape-anisotropic members 32, if the additive amount of the rheological control agent is less than 0.05 wt %, there is a risk that a three-dimensional polymer network capable of suppressing movement of the shape-anisotropic members 32 during rest thereof will not be able to be formed. On the other hand, depending on the type of rheological control agent, if the additive amount of the rheological control agent exceeds 10 wt %, the content of the rheological control agent in the dispersion liquid 35 will become too high, which could affect transmittance such as by clouding the dispersion liquid 35, or cause a decrease in alignment speed of the shape-anisotropic members 32 in response to applied voltage due to excessive increase in viscosity of the dispersion liquid 35 and an insufficient decrease in the viscosity of the dispersion liquid 35 during voltage driving of the display device 1, or the like. Therefore, when using the inorganic nanoparticle rheological control agent, it is preferable that the additive amount of the rheological control agent be within the above-mentioned ranges.

(Method of Preparing Dispersion Liquid 35)

Next, a method of preparing the dispersion liquid 35 using the inorganic nanoparticle rheological control agent for the display panel 2 will be described.

First, in step [1], the inorganic nanoparticle rheological control agent (powder) is added to prepare a dispersion liquid 34 having the dispersion medium 31 and the inorganic nanoparticle rheological control agent (thickening agent 33) but not having the shape-anisotropic members 32 (i.e., this dispersion liquid is made of the dispersion medium 31 and the inorganic nanoparticle rheological control agent).

At such time, the inorganic nanoparticle rheological control agent is preferably added to the dispersion medium 31 within the range of 0.05 wt % to 10 wt % or more preferably within the range of 0.5 wt % to 3.0 wt % as described above.

Next, in step [2], the inorganic nanoparticle rheological control agent is dispersed in the dispersion medium 31. In other words, when using an inorganic nanoparticle rheological control agent as the thickening agent 33, such as in the present embodiment, the agent does not dissolve in the dispersion medium 31 as with the organic rheological control agent, but rather stably disperses without aggregating.

The inorganic nanoparticles used as the inorganic nanoparticle rheological control agent, as added to the dispersion medium 31, form natural compact clusters due to van der Waals attraction or hydrogen bonding and sink due to the difference in specific gravity with the dispersion medium 31, which causes the dispersion medium 31 (the resulting dispersion liquid 34) to become gel-like. Thus, to disperse stably the nanoparticles, it is necessary to apply shear stress to the compact clusters to break them to a level where the primary aggregates are several dozen to several hundred nm.

Breaking the compact clusters to this primary aggregate level causes displacement by Brownian motion, which exceeds the sinking displacement caused by the difference in specific gravity based on Stokes equation, and this can stably and semi-permanently disperse the compact clusters in the dispersion medium 31.

Due to this, in order to disperse the inorganic nanoparticles (to break the compact clusters), it is necessary to have a stirring dispersion member that can impart shear stress to the compact clusters of inorganic nanoparticles (preferably a member that has higher energy than an ultrasonic generator or the like).

One example of such a stifling dispersion member includes the stirring device “Thin-Film Spin System High-Speed Mixer T.K. FILMIX (registered trademark)” manufactured by PRIMIX Corporation.

It should be noted that the stifling parameters have no particular limitations as long as the inorganic nanoparticles can be stably dispersed in the dispersion medium 31 as described above, but are preferably a stirring revolution speed of 40 m/s for 300 seconds, for example, and a temperature of the dispersion liquid 34 during stifling of 80° C. or below, for example.

Next, in step [3], a check is performed to ascertain whether the inorganic nanoparticles have been dispersed. At such time, if there is no cloudy gel sedimentation layer caused by compact clusters of the inorganic nanoparticles in the dispersion liquid 34, and if the dispersion liquid 34 is mostly transparent and has fluidity when lightly shaken (i.e., has not become a gel), the process proceeds to the next step.

As above, the stirring of the dispersion liquid 34 in step [2] and the dispersion check in step [3] are repeated until it is confirmed that there is no cloudy gel sedimentation layer in the dispersion liquid 34 in step [3].

Thereafter, in step [4], the stable dispersion of the inorganic nanoparticles (i.e., rheological control agent) is confirmed in order to confirm formation of the three-dimensional mesh structure. Confirmation of stable dispersion of the inorganic nanoparticles can be done by leaving the dispersion liquid 34 from step [3] for a few minutes and then lightly shaking to confirm fluidity (i.e., that the liquid has not become gel-like). It is not possible to confirm visually the three-dimensional mesh structure. Thus, as described above, when the dispersion liquid 34 is at rest, if it can be confirmed that there is fluidity (i.e., the liquid has not become gel-like) by lightly shaking the dispersion liquid 34, then it is assumed that a three-dimensional mesh structure of the inorganic nanoparticle rheological control agent has been formed, and the process proceeds to the next step.

FIG. 14 is a view of results confirming stable dispersion of the rheological control agent by using a different material as an inorganic nanoparticle rheological control agent.

It should be noted that, in FIG. 14, rheological control agent material A is “AEROSIL (registered trademark)-300” and rheological control agent material B is “AEROSIL (registered trademark)-R976.”

As shown by the results of using material A in the left side of FIG. 14, if stable dispersion of the rheological control agent in the dispersion medium 31 has not formed a three-dimensional mesh structure, it can be confirmed that there is a cloudy gel sedimentation layer caused by compact clusters. In contrast, as shown by the results of using material B in the right side of FIG. 14, if the rheological control agent has formed a favorable three-dimensional mesh structure, the dispersion liquid 34 is transparent and slightly cloudy, with no visible cloudy gel sedimentation layer caused by compact clusters.

Furthermore, when the dispersion medium 31 (dispersion liquid 34) is not flowing (when no shear stress is being applied), the primary aggregates of the inorganic nanoparticles lightly bonding together to form the three-dimensional mesh structure increases the viscosity of the dispersion liquid 34, as shown on the right side in FIG. 14.

When the dispersion medium 31 (dispersion liquid 34) is flowing (when shear stress is being applied), the primary aggregates of the inorganic nanoparticles forming the three-dimensional mesh structure or compact clusters in FIG. 14 are merely freely floating around, and viscosity of the dispersion liquid 34 is low. Accordingly, as described above, when the dispersion liquid 34 is at rest, if it can be confirmed that there is fluidity by lightly shaking the dispersion liquid 34, then it is assumed that a three-dimensional mesh structure of the inorganic nanoparticle rheological control agent has been formed, and the process proceeds to the next step.

It should be noted that, as shown by the right side of FIG. 14, the AEROSIL (registered trademark) particles used as the inorganic nanoparticle rheological control agent form a rigid three-dimensional structure. The basic structure of the AEROSIL (registered trademark) structure is not globular, but rather a strong bonding of primary particles of globular bodies, i.e., the primary aggregates maintaining the aggregate structure is the basic structure. The AEROSIL (registered trademark) particles form secondary aggregates based on the primary aggregate structure and form a thread of the three-dimensional mesh structure with very thin branched aggregate particles. The three-dimensional mesh structure is rigid and not susceptible to compressive deformation. The surface of the object to which the primary aggregates have attached forms a shape in which the branched globular particles protrude outward, and the surface has a small contact area and high degree of roughness.

Next, in step [5] and step [6], a similar process to that in step [5] and step [6] in Embodiment 1 is performed to prepare a dispersion liquid 35 having the dispersion medium 31, the rheological control agent (thickening agent 33), and the shape-anisotropic members 32 (in the present example, this dispersion liquid is made of the dispersion medium 31, the inorganic rheological control agent, and the shape-anisotropic members 32).

(Transmittance Control Method)

The dispersion liquid 35 obtained in this manner exhibits the same behavior as the dispersion liquid 35 of Embodiment 1, due to using a rheological control agent exhibiting thixotropic characteristics as the thickening agent 33.

Accordingly, the method of controlling transmittance of the display panel 2 in the present embodiment (the display method of the display panel 2) is the same as in Embodiment 1. Therefore, descriptions thereof will be omitted.

(Effects)

As described above, in a similar manner to Embodiment 1, the present embodiment makes it possible to obtain effects similar to Embodiment 1, due to using a rheological control agent exhibiting thixotropic characteristics as the thickening agent 33. In addition, as described above, the inorganic rheological control agent offers a high degree of freedom for material selection as compared to the organic rheological control agent.

Moreover, as described above, there is a low amount of contamination (introduction of impurities) of the dispersion medium 31 caused by adding the rheological control agent to the dispersion medium 31 (introduction to the dispersion liquid 35), and few risk factors for drops in reliability such as electrolysis during voltage driving of the shape-anisotropic members 32.

Therefore, in a similar manner to Embodiments 1 to 3, it is possible to perform AC (alternating current) driving and to perform driving with a markedly high reliability with both DC (direct current) and AC (alternating current) without risk of electrolysis or the like.

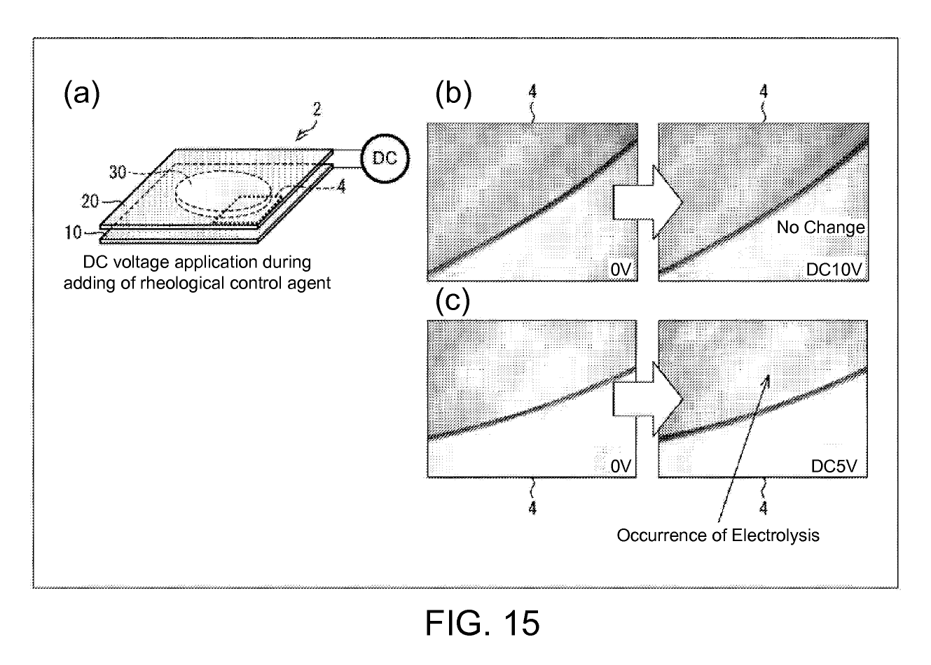

FIG. 15(a) is a perspective view schematically showing a general configuration of the display panel 2, FIG. 15(b) are images taken of an area 4 in FIG. 15(a) shown by the dotted lines when the inorganic nanoparticle rheological control agent was used a thickening agent 33, and FIG. 15(c) are images taken of the area 4 in FIG. 15(a) shown by the dotted lines when the organic rheological control agent was used a thickening agent 33.

It should be noted that, in the examples shown in FIGS. 15(a) to 15(c), the inorganic nanoparticle rheological control agent is “AEROSIL (registered trademark)-R976” and the organic rheological control agent is “BYK (registered trademark)-410.” In FIG. 15(b), a direct-current voltage of 10V is applied, and in FIG. 15(c), a direct-current voltage of 5V is applied.

In the example shown in FIG. 15(c), DC driving is performed using the organic rheological control agent, whereupon electrolysis occurs due to the introduction of impurities to the dispersion medium 31 when the organic rheological control agent is added. It is possible to see the generation of gas and the precipitation of reactive materials to the electrode surface inside the display panel 2.

As shown in FIG. 15(b), however, when using the inorganic nanoparticle rheological control agent, even if a direct-current voltage is applied, electrolysis does not occur, and there are no visible changes such as generation of gas or precipitation of reactive materials to the electrode surface. Due to the results described above, it is understood that using the inorganic nanoparticle rheological control agent as the thickening agent 33 can ensure sufficient reliability, even when performing DC driving.

FIGS. 16(a) to 16(d) are photomicrographs showing the display panel 2 having the dispersion liquid 35 including the rheological control agent being driven by voltage.

It should be noted that, in this example, the photographs were taken with “AEROSIL (registered trademark)-R976S” as the rheological control agent, propylene carbonate at a specific gravity of 1.4 as the dispersion medium 31, aluminum flakes at a specific gravity of 2.7 as the shape-anisotropic members 32, and a cell thickness of 79 μm.

In this example, FIG. 16(a) shows the state in FIG. 1(a), FIG. 16(b) shows the state in FIG. 1(b), FIG. 16(c) shows the states in FIG. 1(d), and FIG. 16(d) shows the state in FIG. 1(g).

In a similar manner to Embodiment 1, when an alternating-current voltage of 5.0V is applied at a frequency of 60 Hz from the initial state (no voltage being applied) in FIG. 16(a), then as shown in FIG. 16(b), the shape-anisotropic members 32 rotate or move such that the long axes thereof become perpendicular to the substrates 10 and 20 from a state parallel with the substrates 10 and 20.

Thereafter, when the voltage is turned OFF, as shown in FIG. 16(c), the memory effect approximately maintains the alignment direction of the shape-anisotropic members 32 and the locations of the shape-anisotropic members 32 in a plan view even after the voltage is turned OFF.

However, when a direct-current (frequency=0 Hz) of 5.0V is applied to the light modulation layer 30, as shown in FIG. 16(d), the shape-anisotropic members rotate or move such that the long axes thereof become parallel with the substrates 10 and 20 from a state perpendicular to the substrates 10 and 20.

In this manner, the present embodiment makes it possible to perform DC driving by using the inorganic nanoparticle rheological control agent as the thickening agent 33.

### Embodiment 5

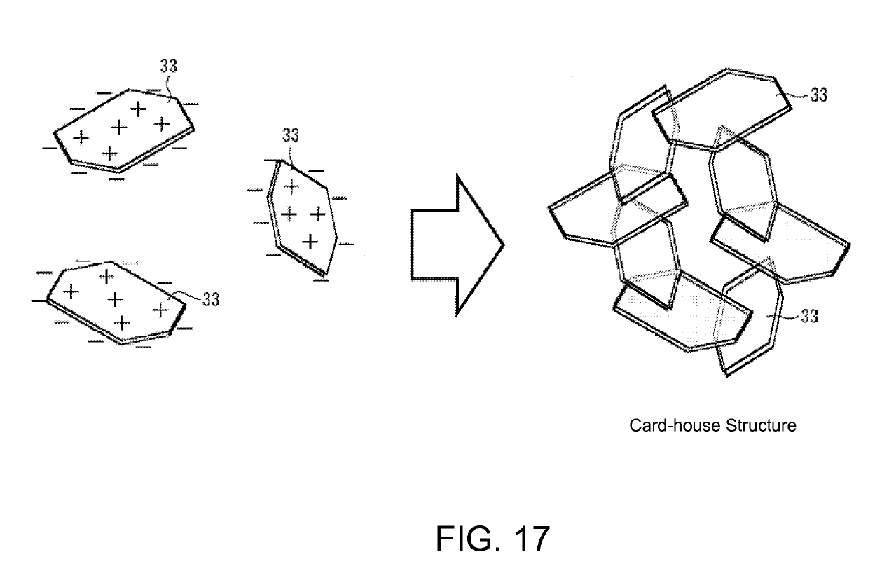

Another embodiment according to the present invention is as described below with reference to FIG. 17. For ease of explanation, the constituting components having the same functions as those described in Embodiments 1 to 4 above are given the same reference characters, and the descriptions thereof are omitted. In the present embodiment, differences among Embodiments 1 to 4 will be explained.

(Thickening Agent 33)

In the present embodiment, an example will be described in which an inorganic clay mineral rheological control agent, which is one type of inorganic rheological control agent exhibiting thixotropic characteristics, is used as the thickening agent 33.

One example of such an inorganic clay mineral rheological control agent includes bentonite.

FIG. 17 is a schematic view of a bentonite (montmorillonite) card-house structure.

Bentonite is clay that has montmorillonite, which is a clay mineral, as the main ingredient thereof. Bentonite (montmorillonite) has a flake-like crystalline structure made of a plurality of layers, and as shown in FIG. 17, the surface of the flakes are negatively charged while the end faces are positively charged.

Purified bentonite (montmorillonite) having this type of montmorillonite as the main ingredient thereof is thickened by swelling in water. When the purified bentonite is dispersed in water, the layer structure causes electrostatic bonding, and as shown in FIG. 17, this forms a three-dimensional associated structure (three-dimensional mesh structure) referred to as a card-house structure. When the card-house structure progresses to a certain degree, the dispersion liquid 35 including the bentonite becomes gel-like and viscosity is generated in the dispersion liquid 35. If shear stress is applied to the dispersion liquid 35, the flake-like crystals aligning in parallel to the flow of the dispersion liquid 35 causes the viscosity of the dispersion liquid 35 to drop, and if the dispersion liquid 35 enters a rest state again (not flowing), the card-house structure will be rebuilt and viscosity of the dispersion liquid 35 will increase again. Due to this, purified bentonite exhibits thickening and thixotropic characteristics.

The bentonite described above may be so-called organically-modified bentonite (organophilic bentonite). Organically-modified bentonite is a material in which the positive ion exchangeability of montmorillonite is used to embed an organic agent between the layers to make it possible to disperse the bentonite in an organic solution.

Examples of the organic agent include quarternary ammonium salts such as dimethylstearylammonium chloride or trimethylstearylammonium chloride, ammonium chloride having a benzyl group or a polyoxyethylene group, phosphonium salt, imidazolium salt, or the like.

The organically-modified bentonite thickens by swelling in an organic solvent. When shear stress is applied to the dispersion liquid 35 including the organically-modified bentonite, the flake-like crystals aligning parallel to the flow of the dispersion liquid 35 causes the viscosity of the dispersion liquid 35 to drop, and if the dispersion liquid 35 enters a rest state again (not flowing), the association caused by hydrogen bonding of the hydroxyl groups at the end faces of the flake-like crystals will cause the flake-like crystals to form a three-dimensional network, thereby increasing the viscosity of the dispersion liquid 35. Due to this, organically-modified bentonite also exhibits thickening and thixotropic characteristics.

The purified bentonite can be commercially available bentonite such as the BEN-GEL series manufactured by HOJUN Co., Ltd., for example. Examples of purified bentonite in the BEN-GEL series include: BEN-GEL types such as “BEN-GEL,” “BEN-GELHV,” “BEN-GELHVP,” “BEN-GEL flakes,” “BEN-GELFW,” “BEN-GELA,” “BEN-GELBRITE11,” or “BEN-GELBRITE23,” “BEN-GELBRITE 25” (all trade names); organic polymer composite purified bentonite referred to as BEN-GELW types such as “BEN-GELW-100” (anionic montmorillonite polymer composite with surface modified by anionic polymer), “BEN-GELW-100U” (montmorillonite polymer composite from carboxyvinyl polymer), “BEN-GELW-300U” (montmorillonite polymer composite from carboxyvinyl polymer), “BEN-GELW-300HP” (montmorillonite polymer composite from carboxyvinyl polymer), or “BEN-GELW-513U” (all trade names); BEN-GELSH types, which is partial plastic purified bentonite, such as “BEN-GELSH” (trade name, silane-treated montmorillonite with end surfaces modified by alkyltrialkoxysilane); and MULTIBEN types, which is a polar organic solvent refined bentonite composite, such as “MULTIBEN” (trade name, propylene carbonate montmorillonite composite).

Examples of the organically-modified bentonite include S-BEN types, such as “S-BEN,” “S-BENC,” “S-BENE,” “S-BENW,” or “S-BENWX” (all trade names); ORGANITE types, such as “ORGANITE” OR “ORGANITET” (all trade names); and easily dispersed types such as “S-BENN-400,” “S-BENNX,” “S-BENNX80,” S-BENNZ,” “S-BENNZ70,” “S-BENNE,” “S-BENNEZ,” “S-BENNO12S,” “S-BENNO12,” or “S-BENNTO” (all trade names).

When using an inorganic clay mineral rheological control agent as the inorganic rheological control agent in this manner, the additive amount of the inorganic clay mineral rheological control agent is preferably, with respect to the dispersion medium 31, ultimately within the range of 0.05 wt % to 10 wt % of the dispersion medium 31, and more preferable within the range of 0.5 wt % to 3.0 wt %, for the same reasons as when using the inorganic nanoparticle rheological control agent as the inorganic rheological control agent.

(Method of Preparing Dispersion Liquid 35)

Next, the method of preparing the dispersion liquid 35 using the inorganic clay mineral rheological control agent for the display panel 2 is described below.

First, in step [1], the inorganic clay mineral rheological control agent is mixed with the dispersion medium 31 to prepare a dispersion liquid 34 having the dispersion medium 31 and the inorganic clay mineral rheological control agent (thickening agent 33) but not having the shape-anisotropic members 32 (i.e., this dispersion liquid is made of the dispersion medium 31 and the inorganic clay mineral rheological control agent).

However, when using an inorganic clay mineral rheological control agent such as bentonite as the inorganic rheological control agent in this manner, first a small amount of the dispersion medium 31 is added to the inorganic clay mineral rheological control agent and a pre-gel is created by a stirring device with high shearing force.

It should be noted that, at such time, the usage amount of inorganic clay mineral rheological control agent (purified bentonite, for example) (i.e., usage amount of inorganic clay mineral rheological control agent during formation of the pre-gel) is set to be within a range of 3 wt % to 10 wt % with respect to the dispersion medium 31.

The “Thin-Film Spin System High-Speed Mixer T.K. FILMIX (registered trademark)” manufactured by PRIMIX Corporation or the like can be used as the stirring device, for example.

In this case, the stirring parameters have no particular limitations as long as the dispersion liquid 34 including the inorganic clay mineral rheological control agent can be turned into a gel, but are preferably a stirring revolution speed of 40 m/s for 300 seconds, for example, and a temperature of the dispersion liquid 34 during stirring of 80° C. or below, for example.

Thereafter, the liquid is left for several hours to a day and forms a stable gel state.

Next, in step [2], the dispersion medium 31 is added to the pre-gel and stirred, which causes the inorganic clay mineral rheological control agent to be dispersed in the dispersion medium 31.

At such time, the added amount of the dispersion medium 31 is set such that the additive amount of the inorganic clay mineral rheological control agent with respect to the dispersion medium 31 becomes within the range of 0.05 wt % to 10 wt % or preferably 0.5 wt % to 3.0 wt %, as described above.

The “Thin-Film Spin System High-Speed Mixer T.K. FILMIX (registered trademark)” manufactured by PRIMIX Corporation or the like can also be used as the stifling device for this time, for example.

The stirring parameters have no particular limitations as long as the inorganic clay mineral rheological control agent is stably dispersed in the dispersion medium 31, but preferably includes a stifling revolution speed of 5 m/s for 300 seconds, for example. In this case, it is not necessary to control the temperature of the dispersion liquid 34 during stirring.

Next, in step [3], a check is performed to ascertain whether the inorganic nanoparticles have been dispersed. At such time, if a gel sedimentation layer caused by compact clusters of the inorganic clay mineral rheological control agent has not formed in the dispersion liquid 34, and if the liquid is transparent and has fluidity when lightly shaken (i.e., has not become a gel), then the process proceeds to the next step.

As above, the stirring of the dispersion liquid 34 in step [2] and the dispersion check in step [3] are repeated until it is confirmed that there is no cloudy gel sedimentation layer in the dispersion liquid 34 in step [3].

Thereafter, in step [4], a stable dispersion check is performed on the inorganic clay mineral rheological control agent to confirm formation of the three-dimensional mesh structure. The confirmation of stable dispersion of the inorganic clay mineral rheological control agent can be performed by lightly shaking the dispersion liquid 34 obtained in step [3] and confirming that there is fluidity (i.e., that the liquid has not become a gel). It is not possible to confirm visually the three-dimensional mesh structure, in a similar manner to Embodiment 4. Thus, as described above, when the dispersion liquid 34 is at rest, if it can be confirmed that there is fluidity (i.e., the liquid has not become a gel) by lightly shaking the dispersion liquid 34, then it is assumed that a three-dimensional mesh structure of the inorganic rheological control agent (the inorganic clay mineral rheological control agent in the present embodiment) has been formed, and the process proceeds to the next step.

Next, in step [5] and step [6], a similar process to that in step [5] and step [6] in Embodiment 1 is performed to prepare a dispersion liquid 35 having the dispersion medium 31, the rheological control agent (thickening agent 33), and the shape-anisotropic members 32 (in the present example, this dispersion liquid is made of the dispersion medium 31, the inorganic rheological control agent, and the shape-anisotropic members 32).

(Transmittance Control Method)

The dispersion liquid 35 obtained in this manner has the same behavior as the dispersion liquid 35 of Embodiment 1 due to using a rheological control agent expressing thixotropic characteristics as the thickening agent 33.

Accordingly, the method of controlling transmittance of the display panel 2 in the present embodiment (the display method of the display panel 2) is the same as in Embodiment 1. Therefore, descriptions thereof will be omitted.

(Effects)

As described above, in a similar manner to Embodiment 1, the present embodiment makes it possible to obtain effects similar to Embodiment 1, due to using a rheological control agent exhibiting thixotropic characteristics as the thickening agent 33.

Furthermore, according to the present embodiment, in a similar manner to the other rheological control agents, shear stress of the dispersion medium 31 (fluid) destroys the three-dimensional network structure (in the present embodiment: the card-house structure, hydrogen bonding among the end surfaces of the flake-like crystals, etc.), and the viscosity of the fluid drops; however, unlike the other rheological control agents, the alignment of the flakes is disturbed at random in response to the electric field applied to drive the shape-anisotropic members 32, and thus the flakes destroy their own network structure. Thus, according to the present embodiment, viscosity during driving (applying voltage) of the shape-anisotropic members 32 drops faster than when the other rheological control agents are used. Therefore, the present embodiment makes it possible to obtain lower drive voltage of the shape-anisotropic members 32, an improvement in response speed, and the like.

Furthermore, according to the present embodiment, the inorganic clay mineral rheological control agent is derived from natural minerals, and thus the materials are very inexpensive, which allows the costs for manufacturing the display device 1 to be suppressed more than with the other embodiments.

(Modification Example for Inorganic Clay Mineral Rheological Control Agent)

It should be noted that, in the present embodiment, examples were described in which bentonite was the main inorganic clay mineral rheological control agent, but sepiolite may be used as the inorganic clay mineral rheological control agent, for example.

Sepiolite is an aqueous magnesium silicate having a chain structure. Sepiolite exhibits a thickening effect by being dispersed in water or the like and has thixotropic characteristics. When a large external force (shear stress) acts on a slurry in which sepiolite has been dispersed in water, the viscosity lowers, but becomes high when the shear stress is stopped. Therefore, sepiolite can also be suitably used as the thickening agent 33 of the present embodiment.

### Modification Examples

In the respective embodiments above, a case was described in which the display device 1 was a transmissive display device, but the shape-anisotropic members 32 can be applied to a reflective display device, transflective display device, or the like, for example. The display panel 2 and display device 1 of the respective embodiments are not limited to the configurations above, and may be given the following configurations.

In the explanations below, the differences among the respective display devices 1 in Embodiments 1 to 5 will be described, and components having the same functions as those described in Embodiments 1 to 5 are assigned the same reference characters and descriptions thereof will be omitted.

(Reflective Type)

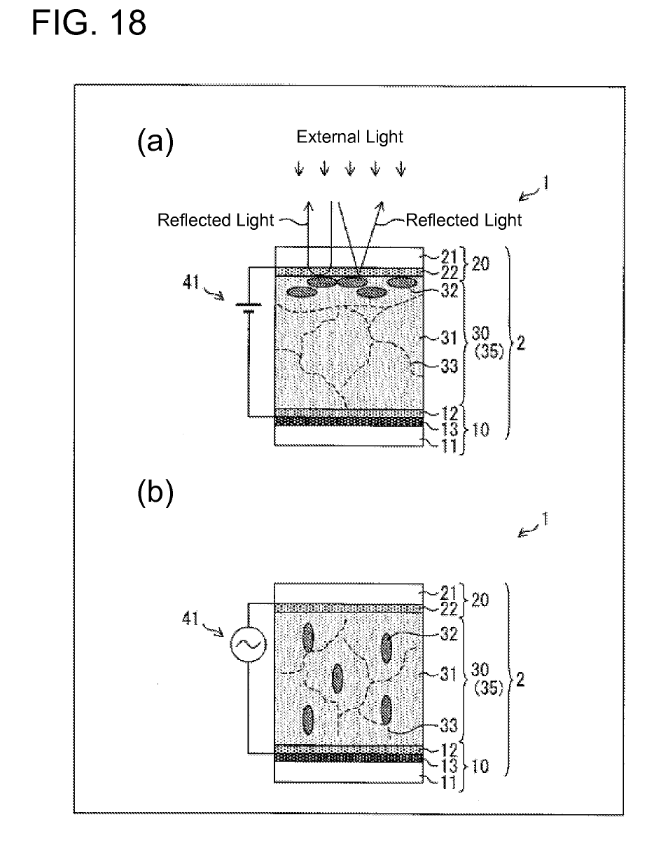

FIGS. 18(a) and 18(b) are cross-sectional views that show a schematic configuration of a reflective display device 1 according to one aspect of the present invention.

The display device 1 of the present example is a reflective display device including a display panel 2 and a driving circuit (not shown) and performs display by reflecting ambient light (incident light) that enters the display panel 2.

The display panel 2 of the present example, in a similar manner to the display panel 2 of Embodiment 1, includes a pair of substrates 10 and 20 disposed facing each other and a light modulation layer 30 between this pair of substrates 10 and 20.

The display panel 2 of the present example has a similar configuration to the display panel 2 of Embodiment 1 except in that, in the present example, the substrate 10 has a light-absorption layer 13 in a layer below the electrodes 12.

That is, the substrate 10 of the present embodiment includes various types of signal lines (scan signal lines, data signal lines, etc; not shown), TFTs, and an insulating film on a glass substrate 11, and on these elements, the light-absorption layer 13 and the electrodes 12 are stacked in the stated order.

The light-absorption layer 13 absorbs light of at least a certain range of wavelengths of the light that enters therein. The light-absorption layer 13 may be colored, and is black, for example.

The material for the colored layer (light absorption layer 13) has no particular limitations, but is a black-colored resist or the like, for example. The thickness of the colored layer may be set as appropriate according to the material of the colored layer or the like, and there is no special limitation on the thickness, but it is preferable that the thickness be within the range of 1 μm to 10 μm, for example, due to such a thickness allowing for sufficient coloration.

If a reflective display device is used as the display device 1 of the present embodiment, then shape-anisotropic members that can reflect visible light are used as the shape-anisotropic members 32. The shape-anisotropic members 32 may be colored. The other characteristics of the shape-anisotropic members 32 are the same as the shape-anisotropic members 32 shown in Embodiment 1.

When a voltage is applied to the light modulation layer 30 by a power source 41 connected to the electrodes 12 and 22, the light modulation layer 30 changes the reflectance of incident light (ambient light) that is incident thereon in accordance with changes in frequency of the applied voltage.

If a voltage (alternating-current voltage) of a 60 Hz frequency is applied to the light modulation layer 30 as a high-frequency wave, for example, then the shape-anisotropic members 32 will rotate or move such that the long axes thereof become parallel with the lines of electric force, as shown in FIG. 18(b). In other words, the shape-anisotropic members 32 align (vertically align) such that the long axes thereof become perpendicular to the substrates 10 and 20. Therefore, the ambient light that has entered the light modulation layer 30 passes (is transmitted) therethrough and is absorbed by the light-absorption layer 13. As a result, the viewer perceives the black color of the light-absorption layer 13 (black display).

On the other hand, if a low frequency voltage of 0.1 Hz, or a direct current voltage (frequency=0 Hz) is applied to the light modulation layer 30 as a low-frequency wave, for example, then the shape-anisotropic members 32 having a charge will be attracted towards an electrode having a charge of the opposite polarity thereof. The shape-anisotropic members 32, in order have the most stable alignment, will rotate or move to attach to the substrates 10 or 20. In other words, as shown in FIG. 18(a), the shape-anisotropic members 32 align (horizontally align) such that the long axes thereof become parallel to the substrates 10 and 20. As a result, the ambient light that enters the light modulation layer 30 is reflected by the shape-anisotropic members 32. Thus, reflective display is attained.

In this manner, when the colored layer (light-absorption layer 13) is provided on the rear surface side of the display panel 2 (i.e., the rear surface side of the electrodes 12 on the rear surface side substrate 10 as seen from the viewer), the reflected color of the shape-anisotropic members 32 is seen when the shape-anisotropic members 32 are horizontally aligned, and the colored layer (light-absorption layer 13) is seen when the shape-anisotropic members 32 are vertically aligned. If the colored layer is black as described above and the shape-anisotropic members 32 are metal flakes, then the metal flakes will reflect during horizontal alignment and cause black display during vertical alignment, for example.

In addition, if the shape-anisotropic members 32 have a size on average of 20 μm or below, for example, forming the surfaces of the shape-anisotropic members 32 with recesses and protrusions confers light-scattering characteristics, and forming the contours of the shape-anisotropic members 32 to have acute recesses and protrusions also scatters reflected light, which enables white display.

If the surface of the shape-anisotropic members 32 is flat (mirror plane), then when the shape-anisotropic members 32 are horizontally aligned as shown in FIG. 18(a), a large portion of the reflecting surface of the shape-anisotropic members 32 can perform display with a high degree of specularity (mirror reflectance).

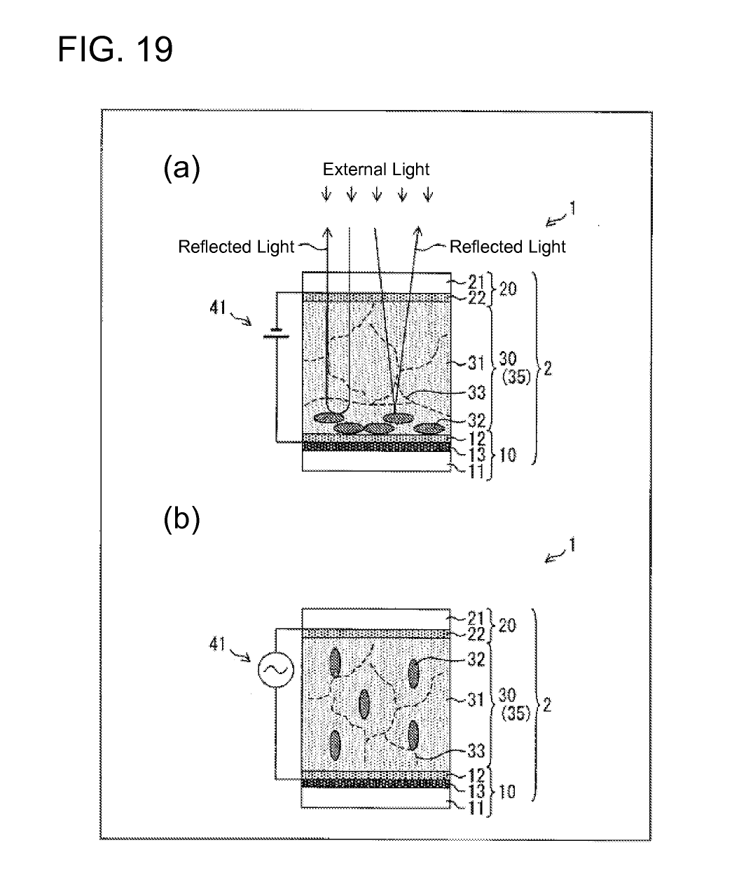

FIGS. 19(a) and 19(b) are cross-sectional views that show a schematic configuration of a reflective display device 1 according to another aspect of the present invention.

It should be noted that, in FIG. 19(a), an example is shown in which, when a direct-current voltage is applied to the light modulation layer 30, the polarity (positive) of the charge of the electrodes 12 of the substrate 10 differs from the polarity (negative) of the charge of the shape-anisotropic members 32, and the shape-anisotropic members 32 are aligned so as to attach to the substrate 10. As shown in FIG. 19(a), in a configuration in which the shape-anisotropic members 32 are arranged on the rear surface substrate 10 side, the shape-anisotropic members 32 (flakes, for example) will appear to be stacked from the viewer's side, thereby forming a surface having recesses and protrusions via the plurality of shape-anisotropic members 32, which can provide a display with strong scattering effects.

Furthermore, when the shape-anisotropic members 32 are horizontally aligned, if the polarity of the direct-current voltage applied to the light modulation layer 30 is controlled to switch between the state in FIG. 18(a) and the state in FIG. 19(a), then providing the black light-absorption layer 13 on the rear surface side makes it possible for the display device 1 to switch among black (vertical alignment; FIG. 18(a) and FIG. 19(b)), white (horizontal alignment; FIG. 19(a)), and mirror reflectance (horizontal alignment (FIG. 18(a)), for example.

When providing a color filter (not shown) on the substrate 20, if a configuration is used in which the shape-anisotropic members 32 are aligned to the substrate 20 on the viewer's side as shown in FIG. 18(a), then it is possible to suppress disparity from occurring between the light modulation layer 30 and the color filter. Therefore, it is possible to achieve a high-quality color display.

In the display device 1, instead of the light-absorption layer 13, a light-reflective layer that performs mirror reflection or scattering reflection may be provided on the rear surface side of the display panel 2, with the shape-anisotropic members 32 being formed of colored members and configured to be able to perform color display during horizontal alignment and reflective display by the reflective layer during vertical alignment.

The display device 1 can also be disposed on the non-display surface (the body surface or the like, which is generally not the image display surface) of a mobile phone or the like, for example. In such a mobile phone device, if the electrodes 12 and 22 of the display device 1 are transparent electrodes, then the body color of the mobile phone device can be displayed on the non-display surface by the shape-anisotropic members 32 being vertically aligned, whereas the color of the shape-anisotropic members 32 can be displayed on the non-display surface or ambient light can be reflected by the shape-anisotropic members being horizontally aligned. It should be noted that the shape-anisotropic members 32 can be horizontally aligned to be used as a mirror (mirror reflectance). In such a display device 1, it is possible to form the electrodes 12 and 22 with segment electrodes or uniformly-planar electrodes, which allows for the circuit configuration to be simplified.

The display device 1 according to the present embodiment can also be applied to a switching panel for 2D/3D display, for example. Specifically, the display device 1, which is the switching panel, is installed on the front surface of an ordinary liquid crystal display panel. The display device 1 has black-colored flakes arranged in stripes, and during 2D display the flakes are vertically aligned and it is possible to see images displayed on the entire surface of the liquid crystal display panel, and during 3D display the shape-anisotropic members 32 are horizontally aligned to form stripes, which displays a left image and a right image on the liquid crystal display panel to form a three-dimensional image. As a result, it is possible to realize a liquid crystal display device by which it is possible to switch between two-dimensional display and three-dimensional display. The configuration above can be applied to a liquid crystal display device that is multiview, including dual view.

(See-Through Type)

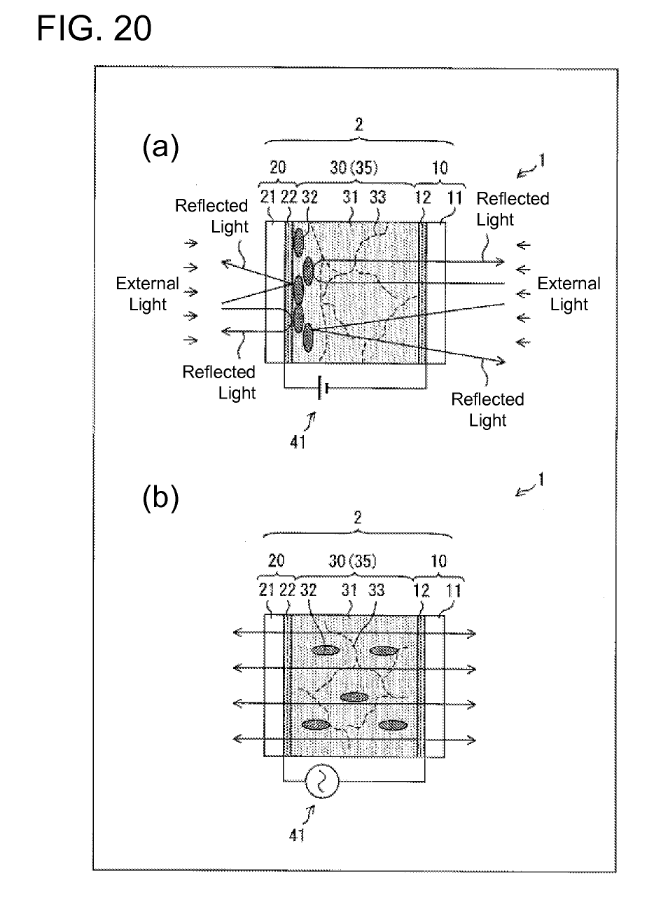

FIGS. 20(a) and 20(b) are cross-sectional views that show a schematic configuration of a see-through type display device 1 according to one aspect of the present invention. It should be noted that, in FIGS. 20(a) and 20(b), a light progression state is shown when the display panel 2 in FIGS. 18(a) and 18(b) is made a see-through type.

As shown in FIG. 20(a), in the display device 1 in FIGS. 18(a) and 18(b), when the light-absorption layer 13 is made transparent, or omitted and the substrates 10 and 20 are made transparent, the ambient light that enters the light modulation layer 30 can be reflected by the shape-anisotropic members 32 even on the rear surface side (substrate 10 side), which enables reflective display. In such a case, when the shape-anisotropic members 32 are horizontally aligned, it is possible to view the reflective color of the shape-anisotropic members 32 or black.

Furthermore, as shown in FIG. 20(b), when the shape-anisotropic members 32 are vertically aligned, the viewer can see the side opposite to the viewer's side through the display panel 2, which allows for a so-called “see-through” display panel. This type of display device 1 and display panel 2 are suitable for shop windows, for example.

It should be noted that, in this example, as shown in FIGS. 20(a) and 20(b), the light-absorption layer 13 was made transparent or omitted in the display device 1 in FIGS. 18(a) and 18(b), but the present embodiment is not limited to this.

The light-absorption layer 13 can also be made transparent or omitted in the display panel 2 shown in FIGS. 19 (a) and 19(b) and the pair of substrates sandwiching the light modulation layer 30 can be made transparent to realize a see-through display panel, for example.

(Transflective Type)

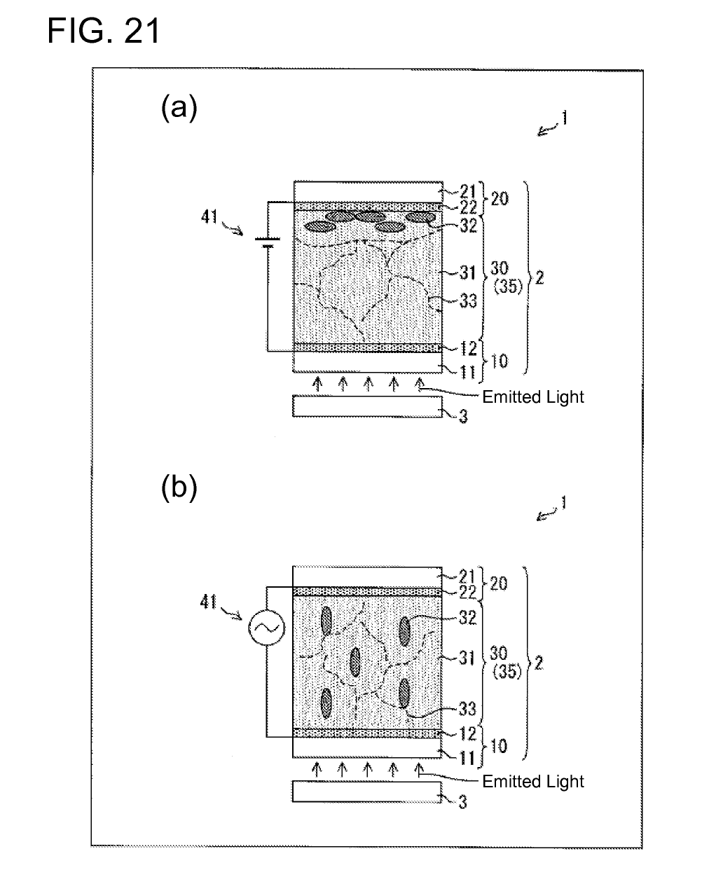

FIGS. 21(a) and 21(b) are cross-sectional views that show a schematic configuration of a transflective display device 1 according to one aspect of the present invention.

The display device 1 according to the present example is a so-called transflective-type display device that includes a display panel 2, backlight 3, drive circuit (not shown), and that performs display with light from the backlight 3 as well as performing display by reflecting incident ambient light.

The display panel 2 of the present example, in a similar manner to the display panel 2 of Embodiment 1, includes a pair of substrates 10 and 20 facing each other and a light modulation layer 30 disposed between this pair of substrates 10 and 20. The configuration of the display panel 2 itself is as shown in Embodiment 1.

The light modulation layer 30 receives a voltage from a power source 41 connected to the electrodes 12, 22 and, in accordance with changes in frequency of the applied voltage, changes the transmittance of light from the backlight 3 and incident on the modulation layer 30 and the reflectance of ambient light that is incident on the light modulation layer 30.

In the present example, if a voltage (alternating-current voltage) of a 60 Hz frequency is applied to the light modulation layer 30 as a high-frequency wave, for example, then the shape-anisotropic members 32 will rotate or move such that the long axes thereof become parallel with the lines of electric force, thereby aligning (vertically aligning) the long axes thereof so as to be perpendicular to the substrates 10 and 20, as shown in FIG. 21(b). Due to this, light that enters the light modulation layer 30 from the backlight 3 passes (is transmitted) therethrough and exits to the viewer's side. In this manner, transmissive display is achieved.

On the other hand, if a low frequency alternating-current voltage of 0.1 Hz, or a direct current voltage with a frequency of 0 Hz is applied to the light modulation layer 30, for example, then the shape-anisotropic members 32 having a charge will be attracted towards an electrode charged with the opposite polarity thereto. The shape-anisotropic members 32, in order have the most stable alignment, will rotate or move to attach to the substrates 10 or 20. In other words, as shown in FIG. 21(a), the shape-anisotropic members 32 are aligned (horizontally aligned) such that the long axes thereof become parallel to the substrates 10 and 20. As a result, ambient light that is incident on the light modulation layer 30 is reflected by the shape-anisotropic members 32. As a result, reflective display is achieved.

In this manner, the display device 1 of the present example performs display by switching between the reflective display mode and the transmissive display mode.

(Bowl-Type Shape-Anisotropic Members 32)

The shape-anisotropic members 32 can also be bowl-shaped (having surfaces with recesses and protrusions) shape-anisotropic members 32 (flakes).

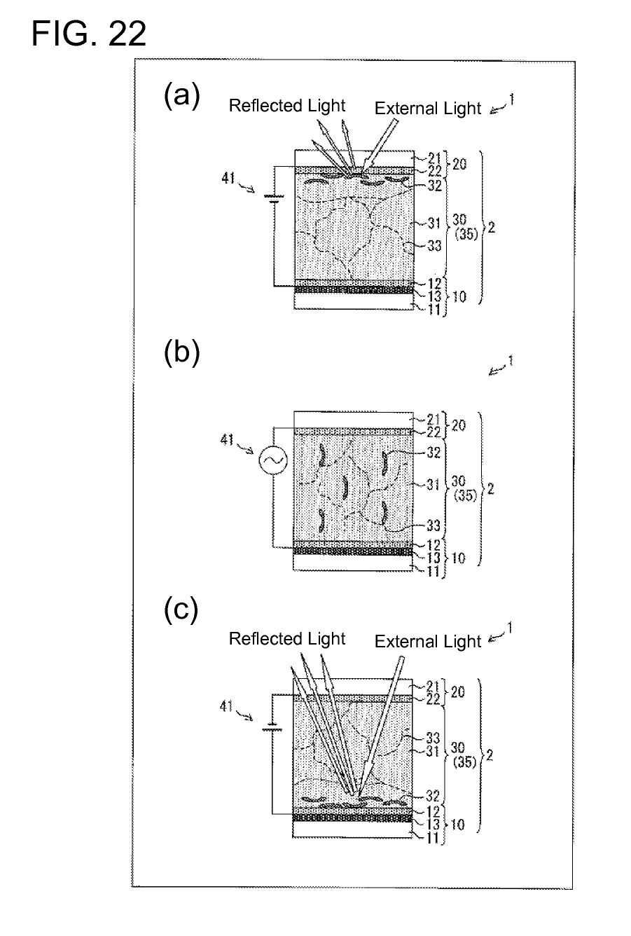

FIGS. 22(a) to 22(c) are cross-sectional views that show one example of a schematic configuration of a display device 1 using the bowl-type shape-anisotropic members 32.

FIGS. 22(a) and 22(b) show a state in which the bowl-type shape-anisotropic members 32 are used in the reflective display device 1 in FIGS. 18(a) and 18(b), and FIG. 22(c) shows a state in which the polarity of the direct-current voltage applied to the light modulation layer 30 is the opposite of that in FIG. 22(a).

The present example makes it possible to improve light-scattering characteristics more than the display device 1 using flat (planar) shape-anisotropic members 32 shown in FIGS. 18(a) and 18(b).

It should be noted that, in FIGS. 22(a) to 22(c), an example is shown in which the display device 1 is the reflective display device 1 as described above, but the shape-anisotropic members 32 may also be used in the transmissive or transflective display device 1.

(Fiber-Like Shape-Anisotropic Members)

The shape-anisotropic members 32 can also be fiber-like shape-anisotropic members 32.

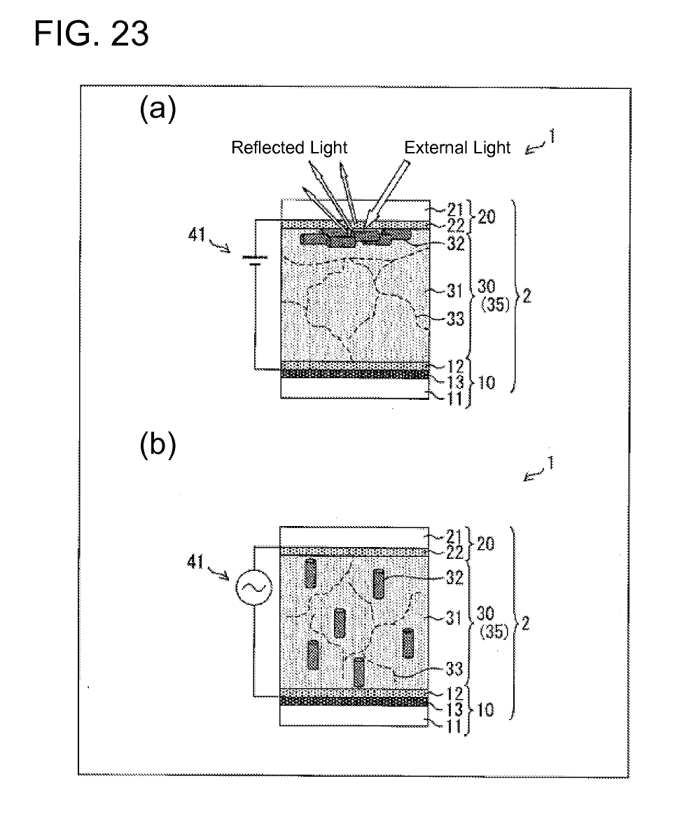

FIGS. 23(a) and 23(b) are cross-sectional views that show one example of a schematic configuration of the display device 1 using fiber-like shape-anisotropic members 32.

It should be noted that, in FIGS. 23(a) and 23(b), a state is shown in which the fiber-like shape-anisotropic members 32 are used in the reflective display device 1 of FIGS. 18(a) and 18(b). The fiber-like shape-anisotropic members (referred to as fibers hereinafter) can be a configuration in which a reflective film (metal or metal and a resin coating) is formed on transparent columnar glass.

FIG. 23(a) shows a state in which the fibers are horizontally aligned to perform reflective display (white display) when a low frequency voltage of 0.1 Hz or direct current voltage is being applied to the light modulation layer 30, for example. When horizontally aligned, ambient light is scattered by being reflected by the reflective films on the fibers, thereby performing white display. FIG. 23(b) shows a state in which the fibers are vertically aligned to perform transmissive display (black display) when a high frequency voltage of 60 Hz (alternating-current voltage) is applied, for example. When vertically aligned, ambient light is reflected by the fibers and then progresses in the substrate 10 direction, thereby being absorbed by the light-absorption layer 13. This results in black display.

(Method of Applying Voltage)

The method of applying voltage to the light modulation layer is not limited to a configuration that switches between direct current and alternating current, but may be a configuration in which the alternating current and the direct current are substantially switched by changing the magnitude (amplitude) of the applied alternating-current voltage by applying an offset voltage to the opposing electrode (common electrode), preferably an offset voltage lower than the maximum alternating-current voltage being applied (i.e., a configuration in which the magnitude of the direct current component and the alternating-current component can be adjusted).

Furthermore, in the display device of the present invention, halftone display can be performed depending on the magnitude and frequency of the alternating-current voltage applied to the light modulation layer, the size of the shape-anisotropic members 32, or the like. By mixing shape-anisotropic members 32 of differing sizes, it is possible to change the alignment state of the respective shape-anisotropic members 32 in accordance with the sizes thereof, for example. As a result, light transmittance can be controlled (halftone display) according to the magnitude and frequency of the alternating-current voltage.

(Thickening Agent)

In Embodiments 1 to 5, examples were described in which the dispersion liquid 35 was a thixotropic fluid or a pseudoplastic fluid, but the thickening agent 33 may be a plastic fluid (Bingham fluid). A plastic fluid is a non-Newtonian fluid having a breakdown value, and when this breakdown value is exceeded, the plastic fluid exhibits a fixed viscosity like a Newtonian fluid. In other words, the thickening agent 33 may be a plasticity-promoting agent.

### SUMMARY

As described above, the display panel according to aspect 1 of the present invention includes first and second substrates 10, 20 disposed facing each other, and a light modulation layer 30 that is sandwiched between the first and second substrate 10, 20 and that controls transmittance of the light that has entered therein in accordance with changes in frequency of the voltage applied thereto. The light modulation layer 30 is made of a dispersion liquid 35 that includes a plurality of shape-anisotropic members 32 which rotate or move in accordance with changes in the magnitude or frequency of the voltage applied to the light modulation layer 30 so as to change the areas thereof projected onto the first and second substrates 10, 20 in a direction normal to the substrates, a dispersion medium 31 that disperses the shape-anisotropic members 32, and a thickening agent 33. When shear stress applied to the dispersion liquid 35 becomes high, the thickening agent 33 causes the viscosity of the dispersion liquid 35 to be less than when shear stress is low.

This configuration, by having the dispersion liquid 35 including the thickening agent 33, makes it possible to suppress deviations of the shape-anisotropic members 32 such as floating, sinking, or in-plane movement of the shape-anisotropic members 32 due to the viscosity of the dispersion liquid 35 increasing when the shear stress applied to the dispersion liquid 35 is low. Meanwhile, during alignment change of the shape-anisotropic members 32, the rotating or moving of the shape-anisotropic members 32 increases the shear stress applied to the dispersion liquid 35, which lowers the viscosity of the dispersion liquid 35 and does not hinder the movement of the shape-anisotropic members 32. Thus, this configuration makes it possible to prevent display anomalies caused by deviations of the shape-anisotropic members 32 without hindering drive performance to the greatest extent possible.

Moreover, the display panel 2 makes it possible, when the shape-anisotropic members 32 are at rest, to increase the viscosity of the dispersion liquid 35 and to maintain the alignment of the shape-anisotropic members 32, which enables memory display.

The display panel 2 according to aspect 2 of the present invention is aspect 1, in which it is preferable that the thickening agent 33 form a three-dimensional mesh structure when the shape-anisotropic members 32 are at rest, which is temporarily destroyed when the shape-anisotropic members 32 rotate or move and thereby apply shear stress to the dispersion liquid 35.

With this configuration, the thickening agent 33 forms the three-dimensional mesh structure when the shape-anisotropic members 32 are at rest, thereby increasing the viscosity of the dispersion liquid 35, and when the shape-anisotropic members 32 rotate or move and thereby apply shear stress to the dispersion liquid 35, the three-dimensional mesh structure is temporarily destroyed, which decreases the viscosity of the dispersion liquid 35. Thus, this configuration makes it possible to prevent display anomalies caused by deviations of the shape-anisotropic members 32 without hindering drive performance to the greatest extent possible while also enabling memory display.

The display panel 2 according to aspect 3 of the present invention is aspect 1 or aspect 2, in which it is preferable that the thickening agent 33 impart thixotropic characteristics to the dispersion liquid 35. In other words, it is preferable that the thickening agent 33 be a thixotropic-imparting agent (thixotropic-promoting agent).

A fluid exhibiting thixotropic characteristics (a thixotropic fluid) has the viscosity thereof decrease when shear stress is high, and increase when shear stress is low. Thus, this configuration makes it possible to prevent display anomalies caused by deviations of the shape-anisotropic members 32 without hindering drive performance to the greatest extent possible, while also enabling memory display.

Furthermore, the dispersion liquid 35 exhibiting thixotropic characteristics does not excessively thicken (relatively little thickening) the liquid when shear speed=0 (during rest). Therefore, with this configuration, it is possible to hold the drive voltage to a relatively low level and to prevent excess increases of the drive voltage.

The display panel 2 according to aspect 4 of the present invention is any one of aspects 1 to 3, in which it is preferable that the thickening agent 33 be a wetting & dispersant agent.

A wetting & dispersant agent is normally used as an anti-pigment aggregation agent and exhibits effects that are similar to a rheological control agent. The wetting & dispersant agent is adsorbed onto the shape-anisotropic members 32 to prevent aggregation of the shape-anisotropic members 32 and to form a three-dimensional mesh structure by the areas with association effects associating with one another. The wetting & dispersant agent also exhibits a thickening effect and weak thixotropic characteristics. Thus, the agent contributes as a thixotropic-promoting agent.

The dispersion liquid 35 that includes the wetting & dispersant agent as the thickening agent 33 has low suppressing effects of deviations of the shape-anisotropic members 32 such as floating or sinking of the shape-anisotropic members 32 or in-plane movement and also has low memory-contributing effects, but the increase in viscosity is low, which makes it possible to hold the drive voltage of the shape-anisotropic members 32 at a low level.

Furthermore, according to the configuration, the wetting & dispersant agent is adsorbed onto the shape-anisotropic members 32 and prevents aggregation of the shape-anisotropic members 32, and thus the shape-anisotropic members 32 do no aggregate and are very easily unwound, as described above. Therefore, by being combined with a suitable drive method that effectively shakes the dispersion liquid 35 injected in the cell interior of the display panel (between the substrates 10 and 20), a swelling dispersant agent can return the dispersion medium 31 to a stable dispersed state as needed.

The display panel 2 according to aspect 5 of the present invention is any one aspects 1 to 3, in which it is preferable that the thickening agent 33 be a rheological control agent made of inorganic nanoparticles.

The rheological control agent made of inorganic nanoparticles exhibits thixotropic and thickening effects and forms a three-dimensional mesh structure through a natural aggregation phenomenon of the inorganic nanoparticles. Therefore, this invention makes it possible to obtain the effects described above.

Moreover, the rheological control agent made of the inorganic nanoparticles has markedly few impurities. Thus, there is a low amount of contamination (introduction of impurities) caused by adding the thickening agent 33 to the dispersion medium 31 (introduction to the dispersion liquid 35), and thus there are few risk factors for drops in reliability such as electrolysis during voltage driving of the shape-anisotropic members 32.

In addition, when modifying the dispersion medium 31 of the dispersion liquid 35, only the surface treatment state of the inorganic nanoparticles need be modified to control aggregability, which allows the rheological control agent made of the inorganic nanoparticles to confer a high degree of freedom when selecting materials than is the case with the organic rheological control agent.

The display panel 2 according to aspect 6 of the present invention is any one of aspects 1 to 3, in which it is preferable that the thickening agent 33 be a rheological control agent made of inorganic clay minerals.

The rheological control agent made of inorganic clay minerals expresses thixotropic and thickening characteristics and forms a three-dimensional mesh structure with the dispersion medium 31. Thus, this configuration makes it possible to obtain the effects described above.

Furthermore, the inorganic clay mineral rheological control agent is derived from natural minerals, and thus the materials are very inexpensive, which allows the costs for manufacturing the display device 1 to be suppressed.

The display panel 2 according to aspect 7 of the present invention is aspect 6, in which it is preferable that the rheological control agent made of inorganic clay minerals be made of bentonite.

With the rheological control agent made of bentonite, shear stress of the dispersion medium 31 (fluid) destroys the three-dimensional network structure (the card-house structure, hydrogen bonding among the end surfaces of the flake-like crystals, etc.), and the viscosity of the fluid drops; however, unlike the other rheological control agents, the alignment of the flakes is disturbed at random in response to the electric field applied to drive the shape-anisotropic members 32, and thus the flakes destroy their own network structure. Thus, according to this configuration, the drop in viscosity when the shape-anisotropic members 32 are being driven (when voltage is being applied) occurs faster than when the other rheological control agents are used. Thus, this configuration makes it possible to obtain effects such as lowering the drive voltage of the shape-anisotropic members 32 and improving response speed.

The display panel 2 according to aspect 8 of the present invention is aspect 1 or 2, in which it is preferable that the thickening agent 33 confer plasticity to the dispersion liquid. In other words, it is preferable that the thickening agent 33 be a pseudoplasticity-imparting (-promoting) agent.

The fluid (pseudoplastic fluid) exhibiting pseudoplasticity has the viscosity thereof decrease when shear stress is high, and increase when shear stress is low. Thus, this configuration makes it possible to prevent display anomalies caused by deviations of the shape-anisotropic members 32 without hindering drive performance to the greatest extent possible, while also enabling memory display.

In addition, the pseudoplastic fluid differs from the thixotropic fluid in that the viscosity when shear speed is zero (i.e., when no voltage is being applied and the shape-anisotropic members 32 are at rest) is markedly high (there is almost no fluidity). Thus, the thickening of the dispersion liquid 35 when the shape-anisotropic members 32 are at rest is greater than if the thickening agent 33 that confers thixotropic characteristics were to be used as the thickening agent 33, thereby making it possible to impart favorable memory properties.

Moreover, the pseudoplastic fluid differs from the thixotropic fluid in that the viscosity to shear speed values are fixed. Therefore, using the thickening agent 33 that imparts pseudoplasticity makes it easier to design for voltage drive control than when using the thickening agent 33 that imparts thixotropic characteristics.

The display panel 2 according to aspect 9 of the present invention is any one of aspects 1 to 8, in which it is preferable that the voltage applied to the light modulation layer is alternating current.

When using direct-current voltage, there is a risk that, when impurities are introduced to the dispersion medium 31, electrolysis will occur and lead to the generation of gas or precipitation of reactive materials to the electrode surface inside the display panel 2. When using alternating current, however, this problem is not likely to occur. Therefore, it is possible to improve the reliability of the display panel 2 and to make manufacturing easier and cheaper without constraints on the type of thickening agent, manufacturing method, injection method, or the like.

The display panel 2 according to aspect 10 of the present invention is any one of aspects 1 to 8, in which the voltage applied to the light modulation layer can be switched between a low frequency that is a direct current at a frequency of 0 Hz or at a prescribed first threshold or below and a high frequency that is at least a prescribed second frequency.

As a result, rotating or moving the shape-anisotropic members 32 changes the area of the shape-anisotropic members 32 projected onto the substrates 10 and 20 as seen from a direction normal to the substrates, which makes it possible to control the transmittance of light that has entered the light modulation layer 30.

The display panel 2 according to aspect 11 of the present invention is aspect 10, in which the shape-anisotropic members 32 align such that the long axes thereof are parallel to the first and second substrates 10 and 20 when a direct-current or low frequency voltage is applied to the light modulation layer 30 or align such that the long axes thereof are perpendicular to the first and second substrates 10 and 20 when a high-frequency voltage is applied to the light modulation layer 30.

The display panel 2 according to aspect 12 of the present invention is any one of aspects 1 to 11, in which it is preferable that the shape-anisotropic members each have a charge.

This configuration makes it possible to rotate or move the shape-anisotropic members 32 by changing the magnitude or frequency of the voltage applied to the light modulation layer 30.

The display panel 2 according to aspect 13 of the present invention is aspect 12, in which it is preferable that, when first electrodes 12 are formed on the first substrate 10 and a second electrode 22 is formed on the second substrate 20 and a direct-current voltage is applied to the first and second electrodes 12 and 22, the polarity of the charge of the second electrodes 12 be opposite to the polarity of the charge of the shape-anisotropic members 32.

This configuration makes it possible for the shape-anisotropic members 32 to be horizontally aligned so as to attach to the second substrate 20.

The display panel 2 according to aspect 14 of the present invention is any one of aspects 1 to 13, in which it is preferable that the shape-anisotropic members 32 each have a reflective surface, and that reflective display be performed by reflecting incident light on these reflective surfaces.

As a result, a reflective display panel 2 can be provided.

The display panel 2 according to aspect 15 of the present invention is aspect 14, in which it is preferable that the display panel 2 have a colored layer (light-absorption layer 13) formed on the substrate 10 that is opposite to the display surface.

As a result, when the shape-anisotropic members 32 are aligned (horizontally aligned) in parallel with the first and second substrates 10 and 20, the reflective color of the shape-anisotropic members 32 can be seen, and when the shape-anisotropic members 32 are aligned (vertically aligned) in a direction perpendicular (normal) to the first and second substrates 10 and 20, the colored layer can be seen.

The display panel 2 according to aspect 16 of the present invention is any one of aspects 1 to 15, in which the shape-anisotropic members 32 are formed in a flake-like shape and have surfaces with recesses and protrusions.

As a result, a strong light-scattering display can be attained.

The display device 1 according to aspect 16 of the present invention includes the display panel according to any one of aspects 1 to 16.

Therefore, it is possible to prevent display anomalies caused by deviations of the shape-anisotropic members 32 without hindering drive performance to the greatest extent allowed and also possible, when the shape-anisotropic members 32 are at rest, for the viscosity of the dispersion liquid 35 to be increased and the alignment of the shape-anisotropic members 32 to be maintained, which allows for memory display.

The present invention is not limited to the respective embodiments mentioned above, and various modifications can be applied within the scope of the claims. Therefore, embodiments that appropriately combine the techniques described in different embodiments are included in the technical scope of the present invention. Moreover, new technical features can be created by combing the technical configurations described in the respective embodiments.

### INDUSTRIAL APPLICABILITY

The present invention confers memory characteristics, and is thus suitable for applications for which zero power consumption during still-image display is effective, such as displays for electronic book terminals, tablet terminals, or the like, for example.

### DESCRIPTION OF REFERENCE CHARACTERS

1 display device
2 display panel
3 backlight
10, 20 substrate
11, 21 glass substrate
12, 22 electrode
13 light-absorption layer
30 light modulation layer
31 dispersion medium
32 shape-anisotropic member
33 thickening agent
34 dispersion liquid
35 dispersion liquid
41 power supply

1: A display panel, comprising:
a first substrate and a second substrate facing each other; and
a light modulation layer sandwiched between the first substrate and the second substrate for controlling transmittance of incident light in accordance with changes in frequency or magnitude of a voltage applied to the light modulation layer,
wherein the light modulation layer is made of a dispersion liquid that includes:
a plurality of shape-anisotropic members that rotate or move in accordance with changes in the frequency or magnitude of the voltage applied to the light modulation layer so as to change an area of said shape-anisotropic members projected onto the first and second substrates as seen from a direction normal to said first and second substrates;
a dispersion medium that disperses said shape-anisotropic members; and
a thickening agent, and
wherein the thickening agent is such that, when shear stress applied to the dispersion liquid is high, the thickening agent reduces the viscosity of the dispersion liquid to be less than when shear stress is low.

2: The display panel according to claim 1,
wherein the thickening agent forms a three-dimensional mesh structure when the shape-anisotropic members are at rest, and
wherein, when the shape-anisotropic members rotate or move and thereby increase the shear stress applied to the dispersion liquid, the three-dimensional mesh structure is temporarily destroyed.

3: The display panel according to claim 1, wherein the thickening agent imparts thixotropic characteristics to the dispersion liquid.

4: The display panel according to claim 1, wherein the thickening agent imparts pseudoplasticity to the dispersion liquid.

5: A display device, comprising:
the display panel according to claim 1.

6: The display panel according to claim 2, wherein the thickening agent imparts thixotropic characteristics to the dispersion liquid.

7: The display panel according to claim 2, wherein the thickening agent imparts pseudoplasticity to the dispersion liquid.

8: A display device, comprising:
the display panel according to claim 2.

9: A display device, comprising:
the display panel according to claim 3.

10: A display device, comprising:
the display panel according to claim 6.

11: A display device, comprising:
the display panel according to claim 4.

12: A display device, comprising:
the display panel according to claim 7.
